(19) United States
(12) Patent Application Publication
(10) Pub. No.: US 2009/0042656 A1
(43) Pub. Date: Feb. 12, 2009

(54) Image Forming apparatus

(75) Inventors: Junya Takigawa, Tokyo (JP); Yoshimi Asayama, Mie (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/219,903

(22) Filed: Jul. 30, 2008

(30) Foreign Application Priority Data
Aug. 7, 2007 (JP) 2007-205799
Oct. 31, 2007 (JP) 2007-282738
Apr. 8, 2008 (JP) 2008-100724

(51) Int. Cl. F16D 3/04

(52) U.S. Cl. 464/102

(57) ABSTRACT

A disclosed image forming apparatus comprises a unit, which includes a rotating body and is detachable from an apparatus body, and a connection unit configured to connect a driven shaft provided in the unit to a drive shaft provided in the apparatus body. The driven shaft is configured to transmit a drive force to the rotating body. The drive shaft is configured to be rotated by a drive force of a drive source. The unit is positioned relative to the apparatus body by connecting the drive shaft and the driven shaft with the connection unit. The rotating body includes at least one of a developing roller, a drive roller of an intermediate transfer belt, a drive roller of a sheet transport belt, a roller configured to transport a sheet, and a secondary transfer roller. The connection unit is a constant velocity joint.

### BACKGROUND OF THE INVENTION

1. Field of the Invention

The present invention relates to an image forming apparatus, such as a copy machine, a printer, a facsimile machine, that includes a unit detachable from the apparatus body.

2. Description of the Related Art

Japanese Patent Laid-Open Publication NO. 2005-17758 (Patent Document 1) discloses an image forming apparatus as described below.

FIG. 24 is a schematic configuration diagram illustrating a developing unit 240 not attached to the apparatus body of the image forming apparatus of Patent Document 1. FIG. 25 is a schematic diagram illustrating the developing unit 240 attached to the apparatus body.

A developing roller shaft 250, which is a driven shaft, extends from a side of a casing 241 of the developing unit 240 as a detachable unit. A coupling gear 252 is fixed to the developing roller shaft 250. Two lugs 253 project from the coupling gear 252. A drive shaft 260, to which a drive force is transmitted from a drive motor (not shown) via a drive force transmission mechanism (not shown), is supported by a real plate 270 of the apparatus body. The drive shaft 260 has a shaft core 261 and a coupling member 262 fixed to an end of the shaft core 261. The coupling member 262 has, at its end face, two lugs 263 that face the two lugs 253 of the coupling gear 252. A recess 264 in which the end of the developing roller shaft 250 is to be inserted and engaged is provided in the coupling member 262.

Referring to FIG. 25, when attaching the developing unit 240 to the apparatus body, the coupling gear 252 of the developing unit 240 is brought into contact with and coupled with the coupling member 262 of the drive shaft 260 of the apparatus body. At the same time, the end of the developing roller shaft 250 is inserted into and engaged with the recess 264 of the coupling member 262. Thus the developing unit 240 is positioned relative to the apparatus body.

According to the configuration of Patent Document 1, as described above, the end of the developing roller shaft 250 is engaged with the recess 264 of the coupling member 262, so that the developing unit 240 is positioned relative to the apparatus body. This prevents misalignment of the shaft center of the developing roller shaft 250 with the shaft center of the drive shaft 260, thereby preventing a developing roller 242 from rotating unevenly.

The image forming apparatus of Patent Document 1, however, has the following problem. Referring to FIG. 25, the developing unit 240 is supported inside the apparatus body by a first support plate 271 and a second support plate 272. However, the attachment positions of the first support plate 271 and the second support plate 272 may be misaligned in the direction perpendicular to the sheet surface due to a variation in the parts accuracy of the apparatus body or the like. In this case, the developing unit 240 is attached at an angle, so that the developing roller shaft 250 is inclined with respect to the drive shaft 260, resulting in an offset angle. If the first support plate 271 and the second support plate 272 are attached in the right places and the developing unit 240 is horizontally attached but the rear plate 270 is tilted, an offset angle is formed between the drive shaft 260 and the developing roller shaft 250. The offset angle causes the torque to be transmitted to vary within a rotation at a drive force transmission unit (in FIG. 25, the joint between the coupling gear 252 and the coupling member 262) that transmits the drive force from the drive shaft 260 to the developing roller shaft 250. The variation in the transmitted torque at the drive force transmission unit negatively affects a drive motor (a drive source) (not shown), resulting in speed fluctuation of the drive motor. This causes uneven rotation of the developing roller 242, resulting in image defects such as uneven density. The uneven density due to the uneven rotation of the developing roller 242 may occur not only in color images but also monochrome (single color) images. Formation of an offset angle between the drive shaft 260 and the developing roller shaft 250 may be prevented by increasing the size accuracy and the attachment accuracy of the components such as the support plates 271 and 272 and the rear plate 270. But this increases the parts cost and the production cost.

### SUMMARY OF THE INVENTION

The present invention is directing toward providing an image formation apparatus capable of rotating a developing roller at a constant speed while reducing the parts cost and the production cost.

According to an aspect of the present invention, there is provided an image forming apparatus that comprises a unit that includes a rotating body and is detachable from an apparatus body; and a connection unit configured to connect a driven shaft provided in the unit to a drive shaft provided in an apparatus body. The driven shaft is configured to transmit a drive force to the rotating body. The drive shaft is configured to be rotated by a drive force of a drive source. The unit is positioned relative to the apparatus body by connecting the drive shaft and the driven shaft with the connection unit. The rotating body includes at least one of a developing roller, a drive roller of an intermediate transfer belt, a drive roller of a sheet transport belt, a roller configured to transport a sheet, and a secondary transfer roller. The connection unit is a constant velocity joint that includes a receiving joint attached to one of the driven shaft and the drive shaft, the receiving joint including an annular space having one open end and plural track grooves axially extending in an outer wall and an inner wall of the annular space and being equally spaced from each other in a circumferential direction; and an inserting joint attached to the other one of the driven shaft and the drive shaft and configured to be partly inserted into the annular space of the receiving joint. The inserting joint holds plural balls that slide along the corresponding track grooves of the receiving joint. The constant velocity joint is configured to connect the driven shaft and the drive shaft by engaging the balls held by the inserting joint into the corresponding track grooves.

According to the above-described image forming apparatus, because a constant velocity joint is used as the connection unit that connects the drive shaft provided in the apparatus body to the driven shaft of the unit removable from the apparatus body, even if an offset angle is formed between the drive shaft and the driven shaft, it is possible to rotate the driven shaft at a constant speed. Therefore, even if an offset angle is formed between the drive shaft and the driven shaft, the developing roller is prevented from being rotated unevenly, so that it is possible to prevent image defects such as uneven density in color images and monochrome (single color) images. Accordingly, without improving the size accuracy and the attachment accuracy of members supporting the drive shaft inside the apparatus body in order to prevent formation of an offset angle between the drive shaft and the driven shaft, it is possible to prevent uneven rotation of the developing roller and thus to reduce the parts cost and production cost.

### BRIEF DESCRIPTION OF THE DRAWINGS

FIG. 1 is a schematic configuration diagram illustrating a printer according to an embodiment;

FIG. 2 is a schematic enlarged view illustrating a process unit;

FIG. 3 is a schematic configuration diagram illustrating a developing unit attached to an apparatus body;

FIG. 4 is a schematic perspective view illustrating a drive force transmission unit of a developing unit;

FIG. 5 is an axial cut-away view illustrating a constant velocity joint;

FIG. 6 is a cross-sectional view taken along line A-A of FIG. 5;

FIG. 7 is a cut-away side view illustrating a cup portion of a receiving joint;

FIG. 8 is a schematic diagram illustrating the cup portion of the receiving joint;

FIG. 9 is a cut-away side view illustrating a ball holding portion of an inserting joint;

FIG. 10A is a schematic configuration diagram illustrating the vicinity of a constant velocity joint wherein a developing unit is not attached to a printer body;

FIG. 10B is a schematic configuration diagram illustrating the vicinity of the constant velocity joint wherein the developing unit is attached to the printer body;

FIG. 11 is a schematic configuration diagram illustrating the vicinity of the constant velocity joint wherein a rear plate is tilted;

FIG. 12 is a schematic configuration diagram illustrating the vicinity of a transfer unit of an image forming apparatus;

FIG. 13 is a diagram illustrating how the transfer unit is attached to the apparatus body;

FIG. 14 is a schematic configuration diagram illustrating the vicinity of a secondary transfer unit of an image forming apparatus;

FIG. 15 is a diagram illustrating how the secondary transfer unit is attached to the apparatus body;

FIG. 16 is a schematic configuration diagram illustrating a sheet transport unit;

FIG. 17 is a diagram illustrating how the sheet transport unit is attached to the apparatus body;

FIG. 18 is a schematic configuration diagram illustrating a sheet transport unit according to another embodiment;

FIG. 19 is a schematic diagram illustrating a tandem type direct transfer color image forming apparatus;

FIG. 20 is a schematic diagram illustrating the vicinity of a transfer unit in the tandem type direct transfer color image forming apparatus;

FIG. 21 is a diagram illustrating how the transfer unit is attached to the tandem type direct transfer color image forming apparatus;

FIG. 22 is a schematic diagram illustrating a tandem type intermediate transfer color image forming apparatus using an intermediate transfer drum;

FIG. 23 is a schematic diagram illustrating a monochrome image forming apparatus;

FIG. 24 is a schematic configuration diagram illustrating a developing unit not attached to an apparatus body of a related-art image forming apparatus; and

FIG. 25 is a schematic configuration diagram illustrating the developing unit attached to the apparatus body of the related-art image forming apparatus.

### DETAILED DESCRIPTION OF THE PREFERRED EMBODIMENT

An electrophotographic printer (hereinafter referred to simply as a printer) as an image forming apparatus of an embodiment of the present invention is described below.

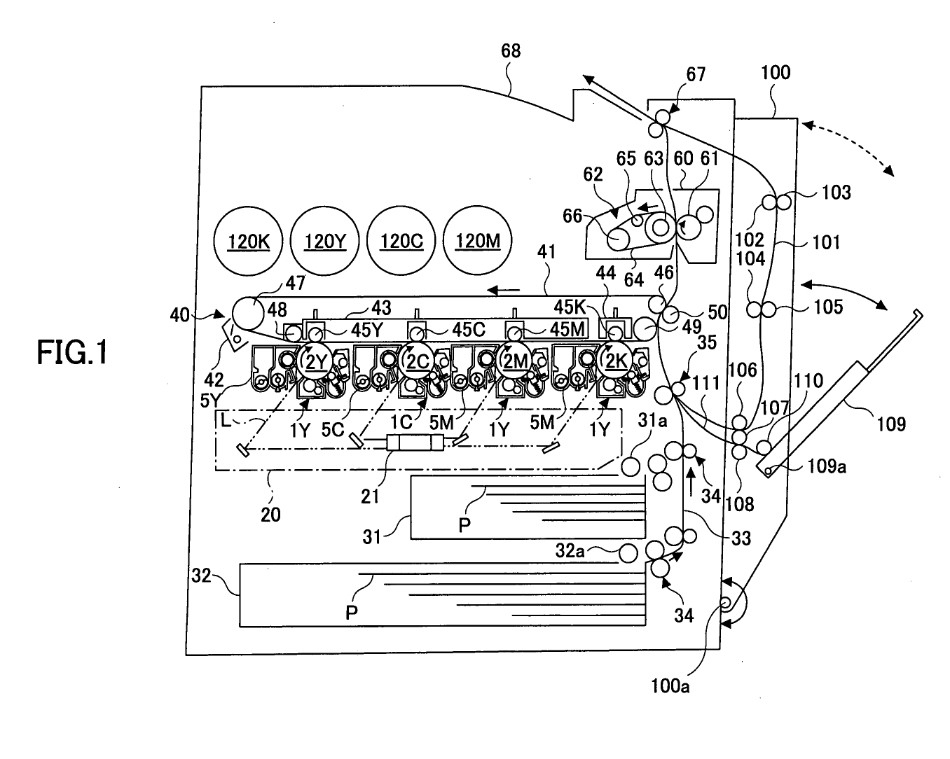

First, the basic configuration of the printer is described below. FIG. 1 is a schematic configuration diagram illustrating the printer. Referring to FIG. 1, the printer includes four process cartridges 1Y, 1C, 1M, and 1K for creating toner images of yellow, cyan, magenta, and black (hereinafter referred to as Y, C, m, and K, respectively), respectively. Although the process cartridges 1Y, 1C, 1M, and 1K use toners of different colors, namely, Y, C, M, and K, the process cartridges 1Y, 1C, 1M, and 1K have the same configuration. The process cartridges 1Y, 1C, 1M, and 1K are replaced when their service lives are over. It is to be noted that because the process cartridges 1Y, 1C, 1M, and 1K have the same configuration, their reference characters Y, C, M, and K indicating the colors of the corresponding toners are omitted in the following description.

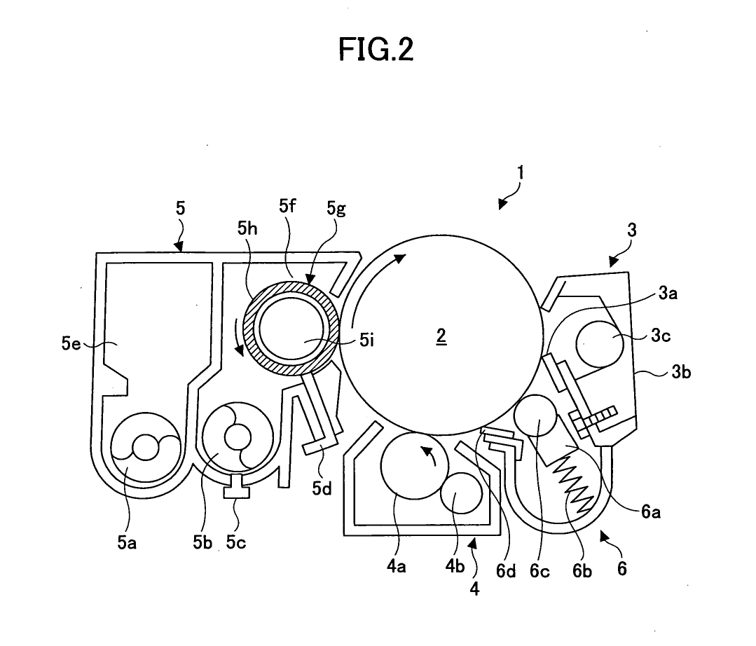

Referring to FIG. 2, the process cartridge 1 includes, inside a frame (not shown), a drum-type photoreceptor 2, a drum cleaning unit 3, a charging unit 4, a developing unit 5, and a lubricant application unit 6. The process cartridge 1 is detachable from the printer body to allow consumable parts to be replaced all at once.

The charging unit 4 uniformly charges the surface of the photoreceptor 2 being rotated clockwise (as viewed in FIG. 2) by a drive unit (not shown). The charging unit 4 of FIG. 2 is a non-contact charging roller type and is configured to cause a charging roller 4a (a rotating body), which rotates counterclockwise (as viewed in FIG. 2), to uniformly charge the photoreceptor 2 without contact with the photoreceptor 2, while receiving a charging bias from a power supply (not shown). Note that other types of charging units such as a scorotron type, a corotron type, and contact roller type may alternatively be used as the charging unit 4.

The charging bias may be applied to the contact type or non-contact type charging roller 4a by superposing an alternating current on a direct current, or by applying only a direct current. The charging bias that superposes an alternating current on a direct current in the contact type charging roller 4a is advantageous in that, even if the resistance of the charging roller 4a fluctuates in response to an environmental change due to constant current control of an alternating current, the surface potential of charging roller 4a is not affected by the fluctuation of the resistance. However, this increases the cost of a power supply unit and has a problem of noise of high frequency alternating current. On the other hand, in the case of the non-contact type charging roller 4a, the surface of the photoreceptor cannot be uniformly charged using a charging bias that superposes an alternating current on a direct current because of influence of fluctuation of the gap between the photoreceptor 2 and the charging roller 4a, resulting in uneven density in an image. Therefore, a unit for correcting the charging bias according to the gap fluctuation is needed.

The charging roller 4a may be rotated by rotation of the photoreceptor 2, or may receive a drive force via a gear or the like from the drive source that drives the photoreceptor 2. In the case of low speed machines, it is common to rotate the charging roller 4a by rotation of the photoreceptor 2. In the case of machines that are required to provide high speed performance and high quality images, it is common to use a drive force from the drive source that drives the photoreceptor 2.

In FIG. 2, a charging roller cleaner 4b is provided that cleans the surface of the charging roller 4a to prevent the photoreceptor 2 from becoming unable to be charged to a target voltage due to contaminants adhering to the charging roller 4a. This prevents defective images due to insufficient charging. The charging roller cleaner 4b is typically formed of melanin and is configured to rotate together with the charging roller 4a.

The developing unit 5 includes a first developer container 5e in which a first transport screw 5a is disposed. The developing unit 5 further includes a second developer container 5f in which a toner concentration sensor 5c including a magnetic permeability sensor (not shown), a second transport screw 5b, a developing roller 5g, and a doctor blade 5d are disposed. These two developer containers 5e and 5f hold a developer (not shown) containing a magnetic carrier and negatively charged toner. The first transport screw 5a is rotated by a drive unit (not shown) to transport the developer in the first developer container 5e from the near side to the far side (as viewed in FIG. 2). Then the developer passes through a communication opening (not shown) in a partition wall between the first developer container 5e and the second developer container 5f and enters the second developer container 5f. The second transport screw 5b is rotated by a drive unit (not shown) to transport the developer from the far side to the near side (as viewed in FIG. 2). The toner concentration sensor 5c, which is fixed at the bottom of the second developer container 5f, detects the toner concentration of the developer being transported. At the upper side of the second transport screw 5b for transporting the developer, a developing roller 5g is disposed inside a developing sleeve 5h, which is rotated counterclockwise (as viewed in FIG. 2). A magnet roller 5i is disposed inside the developing roller 5g. The developer being transported by the second transport screw 5b moves to the surface of the developing sleeve 5h due to a magnetic force of the magnet roller 5i. After the amount of the developer is regulated by the doctor blade 5d, which is spaced apart from the developing sleeve 5h by a predetermined distance, the developer is transported to a developing area facing the photoreceptor 2, so that the toner adheres to an electrostatic latent image on the photoreceptor 2. Thus a toner image is formed on the photoreceptor 2. After the toner is used for developing the image, the developer returns to the second transport screw 5b by rotation of the developing sleeve 5h of the developing roller 5g. When the developer is transported to the near side (as viewed in FIG. 2), the developer returns to the first developer container 5e through the communication opening (not shown).

The detection result of the magnetic permeability of the toner concentration sensor 5c is transmitted as a voltage signal to a control unit (not shown). Because the magnetic permeability of the developer is correlated with the toner concentration of the developer, the toner concentration sensor 5c outputs a voltage of a value corresponding to the toner concentration of the toner. The control unit includes a RAM that stores data of a target output voltage Vtref of the toner concentration sensor 5c. The developing unit 5 compares the value of the output voltage of the toner concentration sensor 5c and the target output voltage Vtref, and drives a toner supply device (not shown) for a period of time according to the comparison result. Thus, in the first developer container 5e, an appropriate amount of toner is supplied to the developer of which toner concentration has been reduced due to the use of toner for developing the image. In this way, the toner concentration of the developer in the second developer container 5f is maintained within a predetermined range.

The cleaning unit 3 is configured to remove residual toner that has not been transferred to the photoreceptor 2 and remains on the surface of the photoreceptor 2. The cleaning unit 3 includes a cleaning blade 3a that abuts the surface of the photoreceptor 2 in a counter direction. The cleaning unit 3 further includes a collection unit 3b that collects the residual toner removed from the surface of the photoreceptor 2 by the cleaning blade 3a. A transport auger 3c that transports the toner collected in the collection unit 3b to a waste toner bottle (not shown) is provided in the collection unit 3b.

The residual toner on surface of the photoreceptor 2 is removed by the cleaning blade 3a. The residual toner accumulated on the edge of the cleaning blade 3a falls into the collection unit 3b. Then the residual toner is transported as waste toner by the transport auger 3c to the waste toner bottle (not shown) and stored therein. The waste toner stored in the waste toner bottle is collected by a maintenance personnel or the like. In an alternative embodiment, the residual toner collected in the collection unit 3b may be transported as recycle toner to the developing unit 5 so as to be used again for development.

The lubricant application unit 6 applies a solid lubricant 6a, which is formed by molding lubricant, onto the surface of the photoreceptor 2 for reducing the friction coefficient of the surface of the photoreceptor 2. The solid lubricant 6a is pressed against a rotating fur brush 6c by a pressure spring 6b, so that the lubricant is applied to the photoreceptor 2 by the fur brush 6c. Zinc stearate is most commonly used as the lubricant. Insulating PET, conductive PET, acrylic fiber or the like may be used as the brush of the fur brush 6c. The lubricant applied on the surface of the photoreceptor 2 is made to have a uniform thickness and is fixed to the surface of the photoreceptor 2 by the lubricant application blade 6d. Application of the lubricant on the surface of the photoreceptor 2 prevents filming of the photoreceptor 2.

Referring back to FIG. 1, an optical writing unit 20 is disposed under the process cartridges 1Y, 1C, 1M, and 1K. The optical writing unit 20 is a latent image forming unit and is configured to emit laser beams L onto each photoreceptor of the process cartridges 1Y, 1C, 1M, and 1K according to image information. Thus, Y, C, M, and K electrostatic latent images are formed on the photoreceptors 2Y, 2C, 2M, and 2K, respectively. The optical writing unit 20 deflects the laser beam L, which is emitted from the light source, using a polygon mirror 21 that is rotated by a motor and directs the laser beams L onto the corresponding photoreceptors 2Y, 2M, 2C, and 2K via plural optical lenses and mirrors.

Under the optical writing unit 20, a first sheet feed cassette 31 and a second sheet feed cassette 32 are aligned vertically. plural transfer sheets P as transfer media are stacked in each of the sheet feed cassettes 31 and 32. A first sheet feed roller 31a and a second sheet feed roller 32a are in contact with the top sheets P in the first sheet feed cassette 31 and the second sheet feed cassette 32, respectively. When the first sheet feed roller 31a is rotated counterclockwise by a drive unit (not shown), the top transfer sheet P in the first sheet feed cassette 31 is discharged toward a sheet feed passage 33 vertically extending at the right side (as viewed in FIG. 1) of the sheet feed cassettes 31 and 32. When the second sheet feed roller 32a is rotated counterclockwise by a drive unit (not shown), the top transfer sheet P in the second sheet feed cassette 32 is discharged toward the sheet feed passage 33. Plural transport roller pairs 34 are disposed inside the sheet feed passage 33. The transfer sheet P fed to the sheet feed passage 33 is passed through the nip between the rollers of each transport roller pair 34 and is transported from the lower side to the upper side (as viewed in FIG. 1) in the sheet feed passage 33.

A resist roller pair 35 is disposed at the end of the sheet feed passage 33. When the transfer sheet P fed by the transport roller pairs 34 is nipped between the rollers of the resist roller pair 35, the resist roller pair 35 stops rotating. Then the resist roller pair 35 restarts rotating to transport the transfer sheet P toward a secondary transfer nip (described below) at an appropriate timing.

An intermediate transfer unit 40 is disposed at the upper side of the process cartridges 1Y, 1C, 1M, and 1K. The intermediate transfer unit 40 includes an intermediate transfer belt 41 that endlessly moves counterclockwise. The intermediate transfer unit 40 includes, in addition to the intermediate transfer belt 41, a belt cleaning unit 42, a first bracket 43, and a second bracket 44. The intermediate transfer unit 40 further includes four primary transfer rollers 45Y, 45C, 45M, and 45K, a secondary transfer backup roller 46, a drive roller 47, an auxiliary roller 48, and a tension roller 49. The intermediate transfer belt 41 extends around these eight rollers, and is endlessly moved counterclockwise by rotation of the drive roller 47. The intermediate transfer belt 41 is nipped between the four primary transfer rollers 45Y, 45C, 45M, and 45K and the photoreceptors 2Y, 2C, 2M, and 2K, respectively, forming primary transfer nips. A transfer bias of a polarity (e.g., positive) opposite to that of the toner is applied to the back surface (inner surface) of the intermediate transfer belt 41. While moving endlessly, the intermediate transfer belt 41 passes through the Y, C, M, and K primary transfer nips, so that the Y, C, M, and K toner images on the photoreceptors 2Y, 2C, 2M, and 2K are transferred onto the outer surface of the intermediate transfer belt 41 and superposed on each other (primary transfer). Thus, a four-color superposed toner image (hereinafter referred to as a “four-color toner image”) is formed on the intermediate transfer belt 41.

The secondary transfer backup roller 46 and a secondary transfer roller 50, which is disposed outside the loop of the intermediate transfer belt 41, form a secondary transfer nip through which the intermediate transfer belt 41 moves. The above-described resist roller pair 35 feeds the transfer sheet P towards the secondary transfer nip at a timing in synchronization with the four-color toner image on the intermediate transfer belt 41. Nip pressure and a secondary transfer electric field, which is formed between the secondary transfer backup roller 46 and the secondary transfer roller 50 to which a secondary transfer bias is applied, cause the four-color toner image on the intermediate transfer belt 41 to be transferred onto the transfer sheet P (secondary transfer) in the secondary transfer nip. With a white color of the transfer sheet P, the four-color toner image forms a full-color toner image.

Toner that is not transferred onto the transfer sheet P in the secondary transfer nip remains on the intermediate transfer belt 41. The remaining toner is removed by the belt cleaning unit 42.

A fixing unit 60 including a pressure roller 61 and a fixing belt unit 62 is disposed at the upper side of the secondary transfer nip. The fixing belt unit 62 of the fixing unit 60 causes a fixing belt 64 to endlessly move around a heating roller 63, a tension roller 65, and a drive roller 66 in the counterclockwise direction. The heating roller 63 includes a heat source, such as a halogen lamp, that heats the fixing belt 64 from the inner side. The pressure roller 61, which rotates clockwise, abuts the outer surface of the fixing belt 64 at a position opposing the heating roller 63. Thus the pressure roller 61 and the heating roller 63 form a fixing nip through which the fixing belt 64 passes.

The transfer sheet P that has passed through the secondary transfer nip is separated from the intermediate transfer belt 41 and is fed into the fixing unit 60. While passing through the fixing nip from the lower side to the upper side, the transfer sheet P is heated by and pressed against the fixing belt 64, so that the full-color toner image is fixed onto the transfer sheet P.

After this fixing process, the transfer sheet P passes through between rollers of a sheet ejection roller pair 67 and is ejected out of the printer. A stacker section 68 is provided on an upper surface of a casing of the printer body. The transfer sheets P ejected from the printer by the sheet ejection roller pair 67 are stacked one on another in the stacker section 68.

Four toner cartridges 120Y, 120C, 120M, and 120K that hold Y, C, M, and K toners are disposed at the upper side of the intermediate transfer unit 40. The Y, C, M, and K toners in the toner cartridges 120Y, 120C, 120M, and 120K are appropriately supplied to the developing units of the process cartridges 1Y, 1C, 1M and 1K. The toner cartridges 120Y, 120C, 120M, and 120K are detachable from the printer body independently from the process cartridges 1Y, 1C, 1M and 1K.

In the printer with the above-described configuration, the four process cartridges 1Y, 1C, 1M and 1K, the optical writing unit 20, the intermediate transfer unit, 40, etc., form a toner image forming unit that forms a toner image on the transfer sheet P (recording medium).

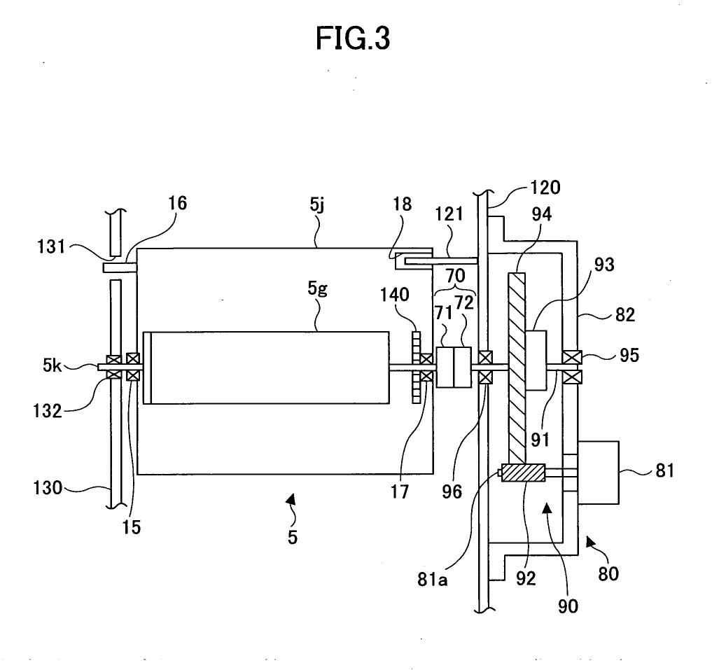

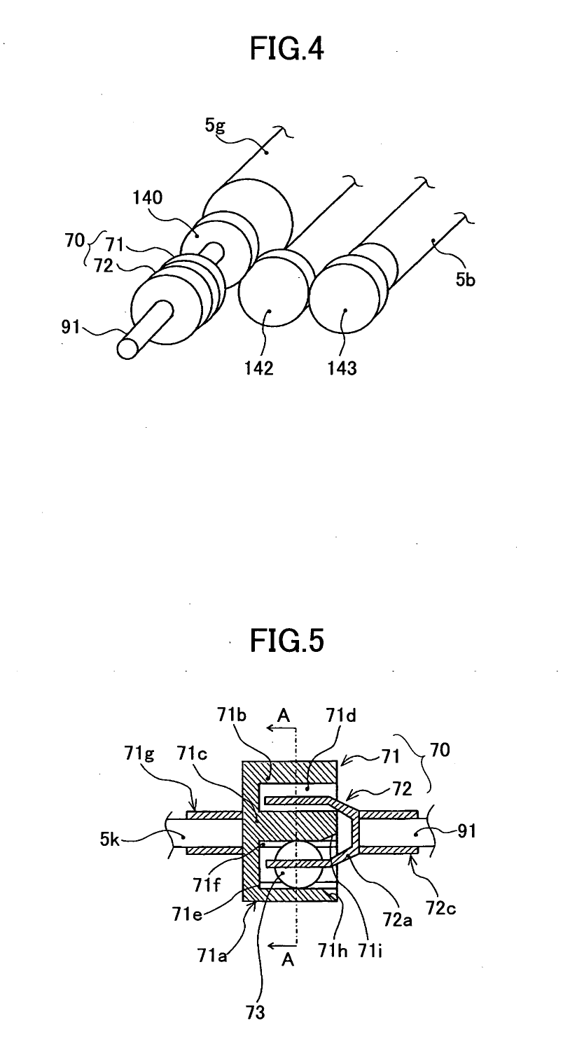

FIG. 3 is a schematic configuration diagram illustrating a developing unit 5 attached to the printer body. A roller shaft 5k as a support shaft of the developing roller 5g is rotatably supported by a case 5j of the developing unit 5. Referring to FIG. 4, a first gear 140 is attached to the roller shaft 5k. The first gear 140 meshes with an idler gear 142, which is attached to a rotary shaft rotatably supported by a frame (not shown). The idler gear 142 meshes with a second gear 143 attached to a shaft of the transport screw 5b. The roller shaft 5k is rotatably supported by the case 5j through bearings 15 and 17.

A bearing 132 that supports the front end of the roller shaft 5k and a receptacle 131 that engages an engagement pin 16 extending from the front face of the case 5j are provided in a front plate 130 of the apparatus body. When the process cartridge 1 is attached to the apparatus body, the engagement pin 16 engages the receptacle 131, and the roller shaft 5k engages the bearing 132, so that the developing unit 5 is supported by the front plate 130. A receiving joint 71 of a constant velocity joint 70 (described below) is attached to the rear end of the roller shaft 5k. When the process cartridge 1 is attached to the apparatus body, the receiving joint 71 is connected to an inserting joint 72 attached to the front end of a drive shaft 91. A guide hole 18 is formed in the rear face of the case 5j. When the developing unit 5 is attached to the apparatus body, a guide pin 121 extending from a rear plate 120 is inserted into the guide hole 18, so that the guide hole 18 guides the developing unit 5.

A drive device 80 is fixed to the surface of the rear plate 120 of the image forming apparatus body opposite to the surface facing the developing unit 5. The drive device 80 includes a holding plate 82, a drive motor 81 (a drive source), and a transmission mechanism unit 90. The drive motor 81 is attached to the rear surface of the holding plate 82 fixed to the rear plate 120 by screws or the like. A motor shaft 81a of the drive motor 81 extends through a circular hole in the rear surface of the holding plate 82, so that the front end of the motor shaft 81a is located inside the holding plate 82 while the motor body is located outside the holding plate 82. The transmission mechanism unit 90 is disposed inside the holding plate 82. The transmission mechanism unit 90 includes a primary drive gear 92, a drive gear 94, and an electromagnetic clutch 93. The primary drive gear 92 is fixed to the motor shaft 81a and meshes with the drive gear 94. The drive gear 94 is fixed to the drive shaft 91 through the electromagnetic clutch 93. The drive shaft 91 is rotatably supported by the rear plate 120 and the holding plate 82 by interposing bearings 96 and 95, respectively.

For a drive force of the drive motor 81 to be transmitted to the developing roller 5g and the transport screw 5b, the electromagnetic clutch 93 is turned ON, thereby connecting the drive shaft 91 and the drive gear 94. On the other hand, when connecting the drive shaft 91 and the roller shaft 5k with the constant velocity joint 70, the electromagnetic clutch 93 is turned OFF, thereby allowing the drive gear 94 to rotate independently from the drive shaft 91. The drive shaft 91 extends through the rear plate 120. The inserting joint 72 (described below) of the constant velocity joint 70 is fixed to the front end of the drive shaft 91. The electromagnetic clutch 93 may be replaced by a one-way clutch that connects the drive shaft 91 to the drive gear 94 when the drive shaft 91 rotates in a direction during a driving operation and disconnects the drive shaft 91 from the drive gear 94 when the drive shaft 91 rotates in the opposite direction.

The constant velocity joint 70 as a connection unit that connects the roller shaft 5k (driven shaft) to the drive shaft 91 is described below with reference to FIG. 5-FIG. 9.

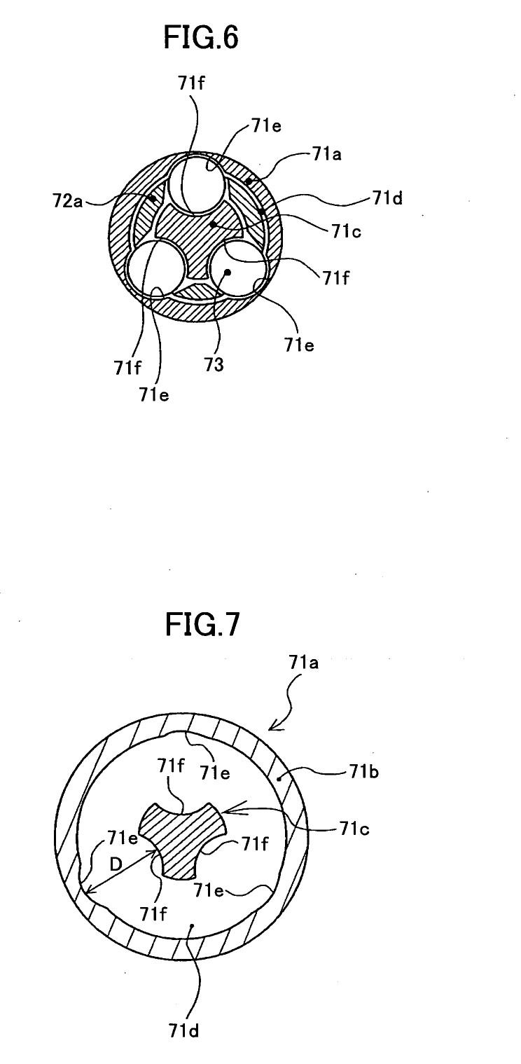

FIG. 5 is an axial cut-away view illustrating the constant velocity joint 70. FIG. 6 is a cross-sectional view taken along line A-A of FIG. 5.

The constant velocity joint 70 connects the drive shaft 91 and the roller shaft 5k that are aligned axially. Connecting the drive shaft 91 to the roller shaft 5k with the constant velocity joint 70 allows a drive force to be transmitted from the drive shaft 91 to the roller shaft 5k at a constant speed even if an offset angle is formed between the drive shaft 91 and the roller shaft 5k.

Referring to FIG. 5, the constant velocity joint 70 includes the receiving joint 71 and the inserting joint 72. The roller shaft 5k is connected to the left axial end (as viewed in FIG. 5) of the receiving joint 71. The drive shaft 91 is connected to the right axial end (as viewed in FIG. 5) of the inserting joint 72.

The receiving joint 71 includes a cup portion 71a having an open axial end from which open axial end the inserting joint 72 is inserted. Referring to FIG. 7, the cup portion 71a includes an outer circular portion 71b, an inner circular portion 71c at the inner side of the outer circular portion 71b, an annular space 71d defined by the gap between the outer circular portion 71b and the inner circular portion 71c, three arcuate outer grooves 71e formed in the inner periphery of the outer circular portion 71b, and three arcuate inner grooves 71f formed in the outer periphery of the inner circular portion 71c. Referring back to FIG. 5, the annular space 71d of the receiving joint 71 has an open axial end from which open axial end the inserting joint 72 is inserted and has a closed axial end. A shaft attachment portion 71g having a cylindrical shape is provided that extends, from the other end of the cup portion 71a, on the center axis of the cup portion 71a. The roller shaft 5k is fitted in and fixed to the shaft attachment portion 71g having a cylindrical shape.

Referring to FIG. 7, the three outer grooves 71e (track grooves) formed in the inner periphery of the outer circular portion 71b extend in the axial direction of the outer circular portion 71b and are circumferentially aligned with a 120° phase difference (angular difference) relative to one another. Similarly, the three inner grooves 71f formed in the outer periphery of the inner circular portion 71c extend in the axial direction of the inner circular portion 71c and are circumferentially aligned with a 120° phase difference relative to one another. The outer grooves 71e face the corresponding inner grooves 71f over the annular space 71d.

A distance D from the outer groove 71e to the corresponding inner groove 71f is made greater than a diameter B of a ball 73 to establish tolerance. If the distance D from the outer groove 71e to the corresponding inner groove 71f is designed to be equal to the diameter B of the ball 73, the distance D might become less than the diameter B due to a manufacturing error or the like. Especially, in this embodiment, because the receiving joint 71 is made by injection-molded resin, the degree of shrinkage varies depending on the production temperature and humidity, so that it is highly likely that the distance D from the outer groove 71e to the inner groove 71f becomes less than the diameter B of the ball 73. If the distance D from the outer groove 71e to the inner groove 71f is less than the diameter B of the ball 73, the sliding resistance of the ball 73 to the outer groove 71e and the inner groove 71f is increased. As a result the outer groove 71e and the inner groove 71f wear down soon, and the service life of the receiving joint 71 is reduced. Furthermore, if the distance D from the outer groove 71e to the inner groove 71f is less than the diameter B of the ball 73, the ball 73 is somewhat press fitted between the outer groove 71e and the inner groove 71f. Then the ball 73 cannot smoothly slide in the outer groove 71e and the inner groove 71f, so that the developing roller 5g cannot rotate at a constant speed. Moreover, great deformation, a so-called creep phenomenon, occurs due to a certain load continuously imposed on the inner groove 71f and the outer groove 71e, so that the service life of the receiving joint 71 is reduced.

In this embodiment, because the distance D from the outer groove 71e to the inner groove 71f is made greater than the diameter B of the ball 73 to establish tolerance, a gap is formed between the ball 73 and the outer groove 71e and between the ball 73 and the inner groove 71f. This prevents the ball 73 from being press fitted between the outer groove 71e and the inner groove 71f, thereby preventing an increase in the sliding resistance of the ball 73 to the outer groove 71e and the inner groove 71f. Therefore, it is possible to prevent wear of the outer groove 71e and the inner groove 71f and creep phenomenon and to extend the service life of the receiving joint 71. Furthermore, because the ball 73 smoothly slides in the outer groove 71e and the inner groove 71f, it is possible to rotate the developing roller 5g at a constant speed.

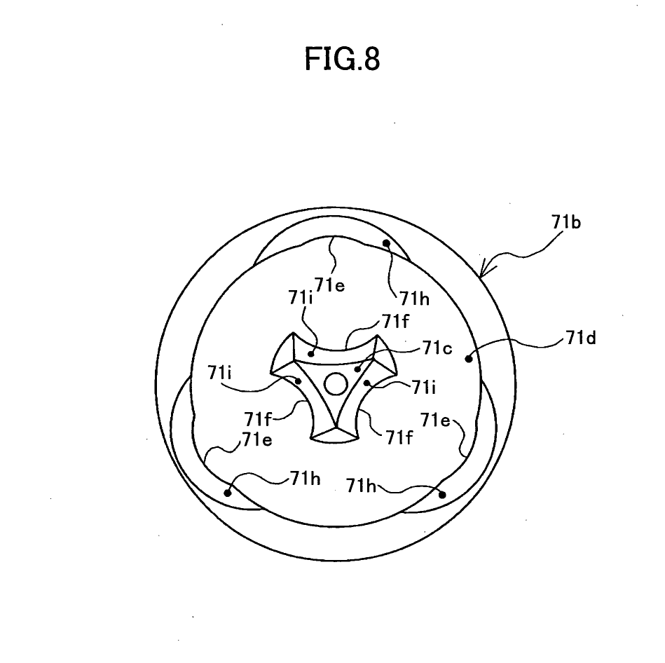

Referring to FIG. 8, an outer groove guide portion 71h having a tapered shape, of which deviation from the central axis and groove width increase toward the open end, is provided at the open end of each outer groove 71e. Further, an inner groove guide portion 71i having a tapered shape, of which deviation from the central axis reduces and groove width increase toward the open end, is provided at the open end of each inner groove 71f. The provision of the guide portions 71h and 71i allows the ball 73 to be guided to the annular space 71d over which the inner groove 71f and the outer groove 71e face, thereby enabling easy insertion of the inserting joint 72 into the receiving joint 71.

The edges of the adjacent inner groove guide portions 71i meet at the open end of the cup portion 71a. This configuration allows, when connecting the receiving joint 71 and the inserting joint 72, the ball 73 to be in contact with the open end of the inner groove guide portion 71i even if there is a phase difference of about 60° between the ball 73 and the track grooves (the outer groove 71e and the inner groove 71f). Therefore, even if there is a phase difference of about 60° between the ball 73 and the track grooves (the outer groove 71e and the inner groove 71f), part of an axial force that is applied to the inner circular portion 71c can be converted into a rotational force by the inner groove guide portion 71i, thereby allowing smooth rotation of the inserting joint 72 relative to the receiving joint 71. This allows a reduction of the insertion resistance of the ball 73 held by the inserting joint 72 into the annular space 71d between the outer groove 71e and the inner groove 71f, thereby allowing smooth insertion of the ball 73 into the annular space 71d between the outer groove 71e and the inner groove 71f.

Referring to FIG. 5, the inserting joint 72 includes a ball holding portion 72a having a cylindrical shape and a shaft attachment portion 72c having a cylindrical shape. The drive shaft 91 is fitted in and fixed to the shaft attachment portion 72c.

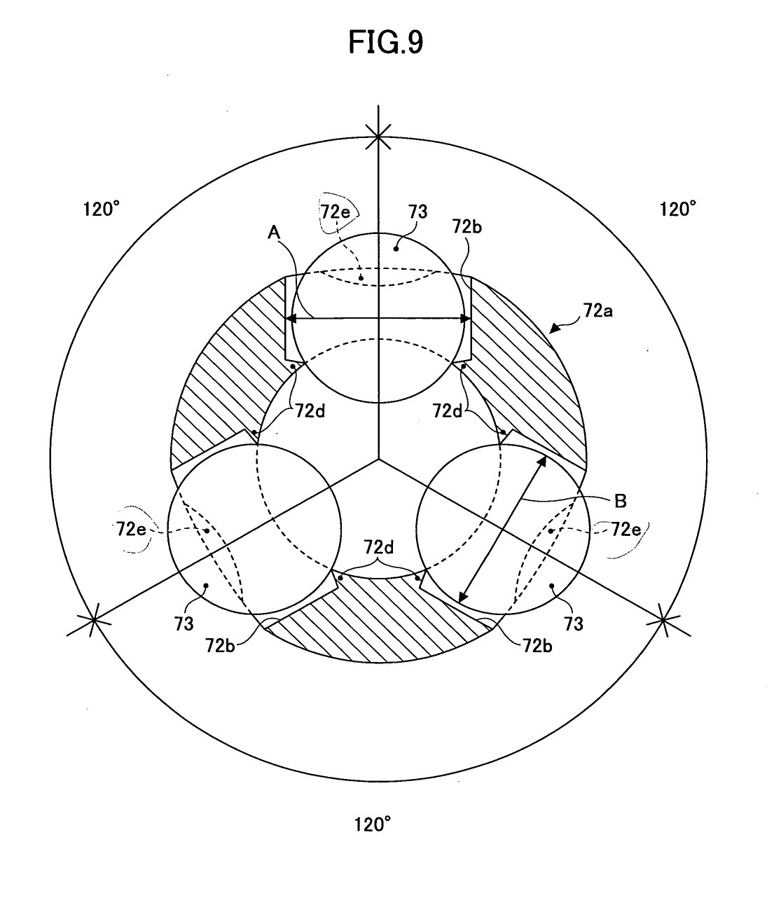

Referring to FIG. 9, the ball holding portion 72a includes three through holes 72b (ball holding holes) and rotatably holds the balls 73 in the through holes 72b. The through holes 72b are formed in a cylindrical peripheral wall and are circumferentially aligned with a 120° phase difference relative to one another.

A diameter A of each through hole 72b is greater than the diameter B of the ball 73. Inner peripheral retaining projections 72d each projecting from the inner surface at the inner peripheral end of the through hole 72b are disposed with a 180° phase difference relative to one another. Outer peripheral retaining projections 72e each projecting from the inner surface at the outer peripheral end of the through hole 72b are disposed with a 180° phase difference relative to one another. The outer peripheral retaining projections 72e are disposed with a 90° phase difference relative to the inner peripheral retaining projections 72d. Each outer peripheral retaining projection 72e prevents the ball 73 in the through hole 72b from coming out from the outer periphery of the ball holding portion 72a. Each inner peripheral retaining projection 72d prevents the ball 73 in the through hole 72b from coming out from the inner periphery of the ball holding portion 72a. Because the diameter A of the through hole 72b is greater than the diameter B of the ball 73, the ball 73 can move radially within the through hole 72b. Therefore, during insertion of the ball holding portion 72a of the inserting joint 72 into the receiving joint 71, when the ball 73 hits the outer circular portion 71b of the receiving joint 71, the ball 73 moves toward the central axis of the inserting joint 72. This allows smooth insertion of the ball holding portion 72a of the inserting joint 72 into the annular space 71d of the receiving joint 71.

When the cylindrical ball holding portion 72a of the inserting joint 72 is inserted in the annular space 71d in the cup portion 71a of the receiving joint 71, the three balls 73 held by the ball holding portion 72a of the inserting joint 72 are disposed between the corresponding outer grooves 71e and inner grooves 71f formed in the inner periphery of the outer circular portion 71b of the receiving joint 71 and the outer periphery of the inner circular portion 71c, respectively, and are thus prevented from moving in the normal line direction. However, because the outer grooves 71e and the inner grooves 71f extend in the axial direction, the balls 73 can move in the axial direction.

When the cylindrical ball holding portion 72a of the inserting joint 72 is inserted in the annular space 71d of the cup portion 71a of the receiving joint 71, the three balls 73 held by the ball holding portion 72a of the inserting joint 72 are engaged in the annular space 71d by the corresponding outer grooves 71e and inner grooves 71f.

In this embodiment, the track grooves (the outer grooves 71e and the inner grooves 71f) for engaging the balls 73 are provided in the inner periphery of the outer circular portion 71b and the outer periphery of the inner circular portion 71c. In an alternative embodiment, either the outer grooves 71e or the inner grooves 71f may be provided.

The receiving joint 71 and the inserting joint 72 are preferably molded parts of synthetic resin that can be processed by injection molding. The injection-moldable synthetic resin may be thermoplastic resin or thermosetting resin. The injection-moldable synthetic resin includes crystalline resin and non-crystalline resin, either one of which can be used. However, in the case of forming the inserting joint 72 by injection molding, because the retaining projections 72e are forcibly removed from the mold, if the toughness is low, the retaining projections 72e might be broken upon removal from the mold. In view of this, crystalline resin is more preferable than non-crystalline resin, because non-crystalline resin has lower toughness and is suddenly broken in response to application of torque greater than the acceptable level of torque. Forming the receiving joint 71 and the inserting joint 72 by injection molding is easier and cheaper than forming the receiving joint 71 and the inserting joint 72 by cutting or other methods.

Synthetic resin having relatively high lubrication properties is preferably used. Examples of such synthetic resin include polyacetal (POM), nylon, fluorine resin (e.g., PFA, FEP, and ETFE), injection-moldable polyimide, polyphenylene sulfide (PPS), wholly aromatic polyester, polyetheretherketone (PEEK), and polyamideimide. These synthetic resins may be used alone or as a mixture of two or more of them as a polymer alloy. Synthetic resins having relatively low lubrication properties may also be used as a polymer alloy containing one or more of the above described synthetic resins.

The most preferable synthetic resin is one that provides sliding properties, namely, POM, nylon, PPS, and PEEK. Examples of nylon include nylon 6, nylon 66, nylon 610, nylon 612, nylon 11, nylon 12, nylon 46, and semiaromatic nylon having an aromatic ring in its molecular chain. Among these, POM, nylon and PPS provide good heat resistance and sliding properties and are relatively inexpensive, so that using them can reduce the cost of the constant velocity joint 70. PEEK provides good mechanical strength and sliding properties without containing reinforcement and lubricant, so that using PEEK can improve the performance of the constant velocity joint 70.

Since the receiving joint 71 and the inserting joint 72 are formed of a resin material, the weight of the constant velocity joint 70 can be reduced compared to the weight of a constant velocity joint having a receiving joint 71 and an inserting joint 72 formed of a metal material. The receiving joint 71 and the inserting joint 72 formed of resin that provides sliding properties enable the balls 73 to smoothly slide along the track grooves (the outer grooves 71e and the inner grooves 71f) of the receiving joint 71 without applying grease to the annular space 71d. Therefore, it is possible to reduce the operating noise compared to a receiving joint 71 and an inserting joint 72 formed of a metal material. Alternatively, the balls 73 may be formed of resin that provides sliding properties so that the balls 73 can slide smoothly along the track grooves. It should be apparent that all of the balls 73, the receiving joint 71, and the inserting joint 72 may be formed of resin that provides sliding properties. Alternatively, only the cup portion 71a of the receiving joint 71 and the ball holding portion 72a of the inserting joint 72 may be formed of resin that provides sliding properties.

The receiving joint 71 is preferably attached to the roller shaft 5k. The balls 73 slide more on the receiving joint 71 than on the inserting joint 72, and therefore the receiving joint 71 wears faster than the inserting joint 72 and reaches the end of its service life sooner. Attaching the receiving joint 71 to the roller shaft 5k allows the receiving joint 71 to be easily removed from the apparatus body together with the developing unit 5. That is, removing the developing unit 5 from the apparatus body allows replacement of the receiving joint 71. Therefore, compared to the case where the inserting joint 72 is attached to the roller shaft 5k, maintenance can be performed more easily.

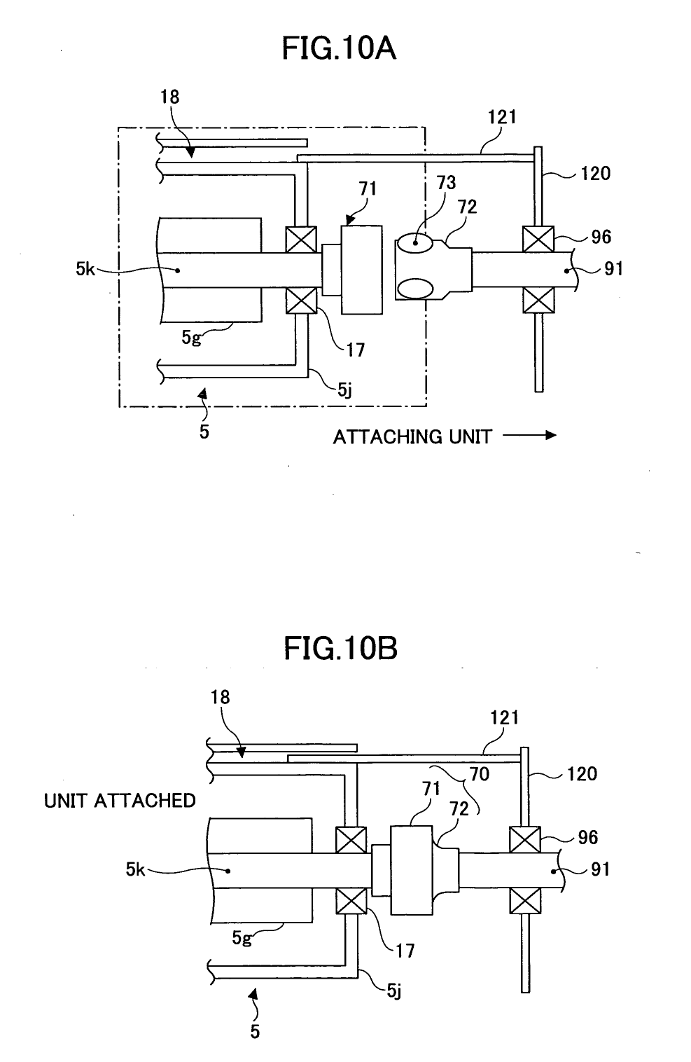

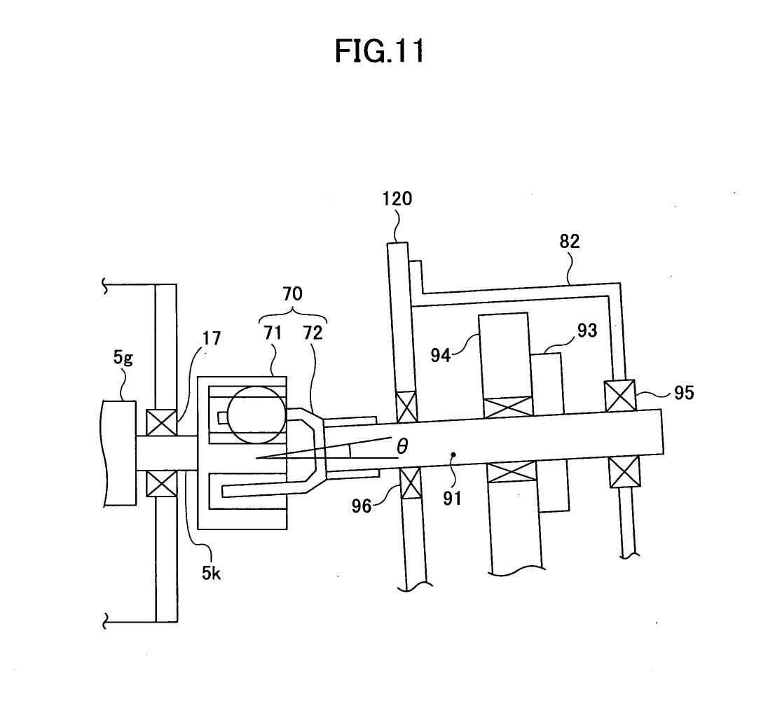

The following describes how the developing unit 5 is attached to the apparatus body with reference to FIG. 10A and FIG. 10B.

FIG. 10A is a schematic configuration diagram illustrating the vicinity of the constant velocity joint 70 wherein the developing unit 5 is not attached to the printer body. FIG. 10B is a schematic configuration diagram illustrating the vicinity of the constant velocity joint 70 wherein the developing unit 5 is attached to the printer body.

The front plate 130 (FIG. 3) is opened, and the developing unit 5 is inserted into the printer body. Thus, as shown in FIG. 10A, the guide pin 121 is inserted into the guide hole 18 of the developing unit 5. With guide pin 121 inserted in the guide hole 18, the developing unit 5 is further inserted into the apparatus body, so that the developing unit 5 is guided by the guide pin 121 to a position where the inserting joint 72 is inserted into the annular space 71d (see FIG. 5) of the receiving joint 71. In this step, the electromagnetic clutch 93 is OFF to allow the drive shaft 91 to rotate freely relative to the drive gear 94 (see FIG. 3).

When the developing unit 5 is further inserted into the printer body, the ball holding portion 72a of the inserting joint 72 is inserted into the annular space 71d of the receiving joint 71. In this step, if the phase of the balls 73 is different from the phase of the track grooves (the outer grooves 71e and the inner grooves 71f), the balls 73 are guided by the outer groove guide portions 71h and the inner groove guide portions 71i and are rotated while moving in the insertion direction of the developing unit 5, so that the phase of the balls 73 matches the phase of the track grooves (the outer grooves 71e and the inner grooves 71f). Since the electromagnetic clutch 93 is OFF to allow the drive shaft 91 to rotate freely relative to the drive gear 94, the rotational load imposed on the inserting joint 72 is only the inertial force of the drive shaft 91. Therefore, it is possible to easily rotate the inserting joint 72 and guide the balls 73 to the track grooves (the outer grooves 71e and the inner grooves 71f) while realizing a reduction in the insertion resistance of the developing unit 5.

When the phase of the balls 73 is matched to the phase of the track grooves (the outer grooves 71e and the inner grooves 71f), the ball holding portion 72a of the inserting joint 72 is inserted into the annular space 71d of the receiving joint 71, so that the three balls 73 held by the ball holding portion 72a of the inserting joint 72 are engaged in the annular space 71d by the corresponding outer grooves 71e and inner grooves 71f. Thus the developing unit 5 is positioned in the radial direction relative to the apparatus body and is attached inside the apparatus body. When the developing unit 5 is attached inside the apparatus body, the front plate 130 is closed. Then, the front end of the roller shaft 5k is inserted into the bearing 132 fixed to the front plate 130, and the engagement pin 16 engages the receptacle 131. In this way, the developing unit 5 is held by the apparatus body.

For rotating the developing roller 5g, the electromagnetic clutch 93 is turned ON, thereby connecting the drive gear 94 to the drive shaft 91. Then, the drive motor 81 is rotated, so that the motor shaft Bla is rotated, and the primary drive gear 92 fixed to the motor shaft 81a is rotated. The rotation is transmitted to the drive gear 94, so that a drive force is transmitted to the drive shaft 91. When the drive shaft 91 is rotated by the transmitted drive force, the drive force is transmitted to the receiving joint 71 via the three balls 73.

In this embodiment, the roller shaft 5k of the developing roller 5g is used as a main reference for positioning the developing unit 5 relative to the apparatus body, thereby preventing the roller shaft 5k from being misaligned with the shaft center of the drive shaft 91. However, in case the rear plate 120 is attached to the apparatus body at an angle due to an assembly error or a manufacturing error, the drive shaft 91 is tilted, so that an offset angle θ is formed between the drive shaft 91 and the roller shaft 5k. If the center of the bearing 132 attached to the front plate 130 is misaligned with the shaft center of the roller shaft 5k in the radial direction due to an attachment error of the front plate 130 or the rear plate 120 or the like, when the developing unit 5 is held by the apparatus body, the roller shaft 5k is tilted, so that an offset angle θ is formed between the drive shaft 91 and the roller shaft 5k.

In this embodiment, the constant velocity joint 70 is used for connecting the drive shaft 91 and the roller shaft 5k. Therefore, even if an offset angle θ is formed between the drive shaft 91 and the roller shaft 5k, a velocity fluctuation factor is eliminated by sliding movements of the balls 73 in the axial direction in the annular space 71d between the inner grooves 71f and the outer grooves 71e of the receiving joint 71, thereby enabling constant speed rotation of the roller shaft 5k. It is therefore possible to rotate the developing roller 5g at a constant speed and prevent image defects such as uneven print density without improving the attachment accuracy and parts accuracy for preventing formation of the offset angle θ. Accordingly, it is possible to prevent image defects such as uneven density while reducing the production cost and the parts cost.

The constant velocity joint 70 includes three components, namely, the receiving joint 71, the inserting joint 72, and the balls 73. That is, it is possible to achieve constant speed rotation of the roller shaft 5k and connection between the roller shaft 5k and the drive shaft 91 using a small number of components, thereby realizing a reduction in the cost of the apparatus.

It is preferable that the receiving joint 71 be attached to the roller shaft 5k so that the roller shaft 5k is connected to the drive shaft 91 by the receiving joint 71. The developing roller 5g has greater torque than the torque of the transport screw 5b. If the shaft of the transport screw 5b is connected to the drive shaft 91, the drive force of the drive motor 81 is transmitted to the developing roller 5g via the second gear 143 fixed to the shaft of the transport screw 5b. In the case where the roller shaft 5k is connected to the drive shaft 91, the torque of the developing roller 5g is applied to the constant velocity joint 70 and a transmission member disposed upstream of the constant velocity joint 70 in the direction in which the drive force is transmitted. However, in the case where the shaft of the transport screw 5b is connected to the drive shaft 91, the torque of the developing roller 5g is applied not only to the constant velocity joint 70 and the transmission member disposed upstream of the constant velocity joint 70 in the direction in which the drive force is transmitted, but also to other transmission members in the developing unit 5 such as the idler gear 142 and the first gear 140. As a result, in the case where the shaft of the transport screw 5b is connected to the drive shaft 91, the service lives of the transmission members in the developing unit 5 are reduced compared to the case where the roller shaft 5k is connected to the drive shaft 91. That is, attaching the receiving joint 71 to the roller shaft 5k of the developing roller 5g, which has the highest torque, for transmitting the drive force from the roller shaft 5k allows the transmission members in the developing unit 5 to have longer service lives.

In this embodiment, the electromagnetic clutch 93 is disposed in the transmission mechanism unit 90 of the drive device 80. In an alternative embodiment, a clutch may be disposed in the developing unit 5. In this case, when inserting the inserting joint 72 into the receiving joint 71, the roller shaft 5k is disconnected from the first gear 140 by the clutch, so that the rotational load imposed on the receiving joint 71 is only the inertial force of the developing roller 5g. Therefore, if the phase of the balls 73 is not matched to the phase of the track grooves, the receiving joint 71 is easily rotated, so that the phase of the balls 73 is matched to the phase of the track grooves. Thus, the balls 73 can be guided to the track grooves while reducing the insertion resistance of the developing unit 5.

In the above-described embodiment, a constant velocity joint is provided as a connection unit that connects the roller shaft 5k of the developing roller 5g of the developing unit 5 to the drive shaft 91. In an alternative embodiment, a constant velocity joint may be provided as a connection unit that connects the roller shaft of the charging roller 4a of the charging unit 4 to the drive shaft 91 of the apparatus body. In another alternative embodiment, a constant velocity joint may be provided as a connection unit that connects a roller shaft of a lubricant application roller to the drive shaft 91 of the apparatus body. The present invention may be equally applicable to the fixing unit 60, the transfer unit 40, and a secondary transfer unit 500.

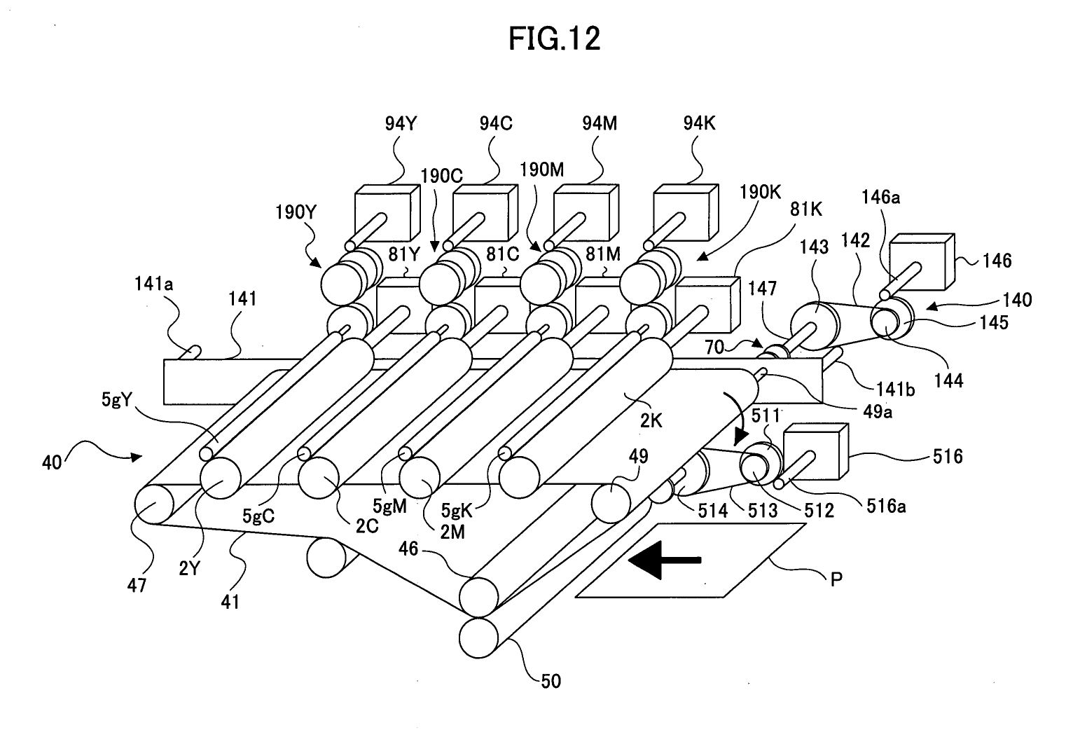

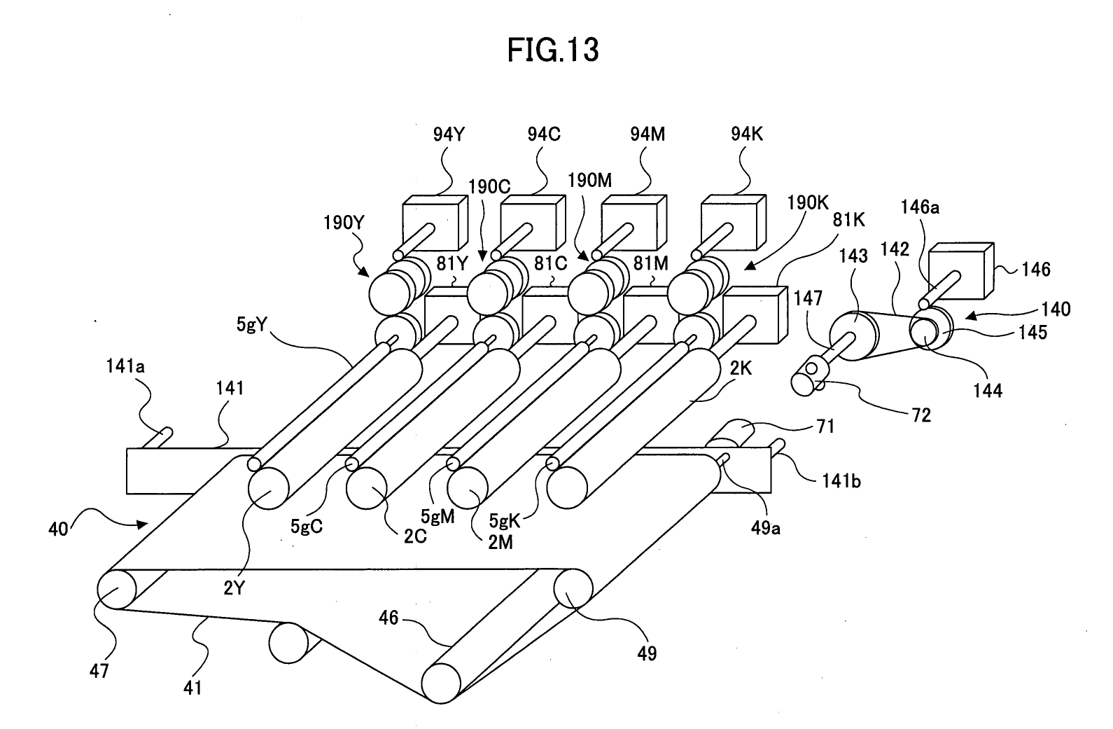

FIG. 12 is a schematic configuration diagram illustrating an example of the transfer unit 40. FIG. 13 is a diagram illustrating how the transfer unit 40 is attached to the apparatus body.

Since the configuration inside the case of the transfer unit 40 shown in FIGS. 12 and 13 is described above, only main components of the transfer unit 40 are described below.

Rotary shafts of a drive roller 49 and driven rollers 47 and 46, around which the intermediate transfer belt 41 extends, are rotatably supported by a near side plate (not shown) and the far side plate 141 of the case of the transfer unit 40. A transfer unit main reference pin 141b and a transfer unit sub reference pin 141a are provided on the far side plate 141 of the transfer unit 40.

In the apparatus body, an intermediate transfer motor 146 (a drive source) and a drive force transmission unit 140 are provided. The drive force transmission unit 140 includes an idler gear 145, a first pulley 144, a second pulley 143, a drive shaft 147, and a timing belt 142. A motor shaft 146a of the intermediate transfer motor 146 meshes with the idler gear 145. The first pulley 144 is coaxially attached to the idler gear 145. The second pulley 143 is fixed to the drive shaft 147. The timing belt 142 extends around the first pulley 144 and the second pulley 143.

A rotary shaft 49a (a driven shaft) of the drive roller 49 extends through the far side plate 141 and is connected to the drive shaft 147 by a constant velocity joint 70 of an embodiment of the present invention.

Referring to FIG. 13, when attaching the transfer unit 40 to the apparatus body, the transfer unit main reference pin 141b is inserted into a main reference hole (not shown) formed in the apparatus body, and the transfer unit sub reference pin 141a is inserted into a sub reference hole (not shown) formed in the apparatus body, so that the transfer unit 40 is positioned relative to the apparatus body. The transfer unit 40 that is positioned relative to the apparatus body is further inserted into the apparatus body, so that the rotary shaft 49a of the drive roller 49 is connected to the drive shaft 147 by the constant velocity joint 70. Thus the transfer unit 40 is attached to the apparatus body.

Using the above-described constant velocity joint 70 for connection between the rotary shaft 49a of the drive roller 49 of the transfer unit 40 and the drive shaft 147 allows the rotation of the drive shaft 147 to be transmitted to the rotary shaft 49a at a constant speed even if an offset angle is formed between the drive shaft 147 and the rotary shaft 49a.

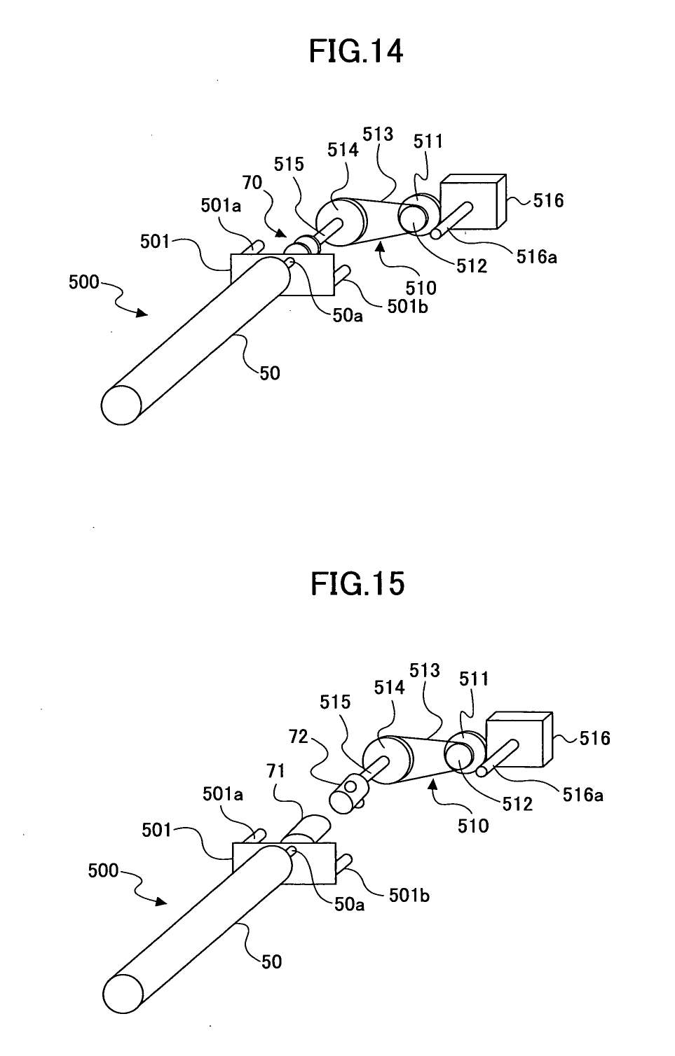

FIG. 14 is a schematic configuration diagram illustrating the secondary transfer unit 500. FIG. 15 is a diagram illustrating how the secondary transfer unit 500 is attached to the apparatus body.

A rotary shaft 50a of the secondary transfer roller 50 is rotatably supported by a near side plate (not shown) and a far side plate 501 of a case of the secondary transfer unit 500. A secondary transfer unit main reference pin 501b and a secondary transfer unit sub reference pin 501a are provided on the far side plate 501 of the secondary transfer unit 500.

In the apparatus body, a secondary transfer motor 516 (a drive source) and a drive force transmission unit 510 are provided. The drive force transmission unit 510 includes an idler gear 511, a first pulley 512, a second pulley 514, a drive shaft 515, and a timing belt 513. A motor shaft 516a of the secondary transfer motor 516 meshes with the idler gear 511. The first pulley 512 is coaxially attached to the idler gear 511. The second pulley 514 is fixed to the drive shaft 515. The timing belt 513 extends around the first pulley 512 and the second pulley 514.

The rotary shaft 50a (a driven shaft) of the secondary transfer roller 50 extends through the far side plate 501 and is connected to the drive shaft 515 by a constant velocity joint 70 of an embodiment of the present invention.

Referring to FIG. 15, when attaching the secondary transfer unit 500 to the apparatus body, the secondary transfer unit main reference pin 501b is inserted into a main reference hole (not shown) formed in the apparatus body, and the secondary transfer unit sub reference pin 501a is inserted into a sub reference hole (not shown) formed in the apparatus body, so that the secondary transfer unit 500 is positioned relative to the apparatus body. The secondary transfer unit 500 that is positioned relative to the apparatus body is further inserted into the apparatus body, so that the rotary shaft 50a of the secondary transfer roller 50 is connected to the drive shaft 515 by the constant velocity joint 70. Thus the secondary transfer unit 500 is attached to the apparatus body.

Using the above-described constant velocity joint 70 for connection between the rotary shaft 50a of the secondary transfer roller 50 of the secondary transfer unit 500 and the drive shaft 515 allows the rotation of the drive shaft 515 to be transmitted to the rotary shaft 50a at a constant speed, thereby enabling constant speed rotation of the secondary transfer roller 500, even if an offset angle is formed between the drive shaft 515 and the rotary shaft 50a.

The above-described constant velocity joint 70 may be used for connection between a drive shaft and a sheet transport roller of a sheet transport unit, such as a finisher unit, a sheet feed unit, a reverse unit, and a sheet ejection unit, for transporting transfer sheets P. The finisher unit performs sorting, punching, and stapling while transporting the transfer sheets P that have passed through a fixing device. The finisher unit includes a sheet transport roller for transporting the transfer sheets P. The sheet feed unit feeds a transfer sheet P from a sheet feed cassette storing the transfer sheet P and transports the transfer sheet P to a transfer position where an image is transferred onto the transfer sheet P. The sheet feed unit includes plural sheet transport rollers, a sheet feed roller for feeding the transfer sheet P from the sheet feed cassette, and a resist roller. The reverse unit reverses the transfer sheet P that has passed through the fixing device and transports the transfer sheet P back to the transfer position. The reverse unit includes plural sheet transport roller. The sheet ejection unit transports the transfer sheet P that has passed through the fixing device to the outside of the apparatus. The sheet ejection unit includes plural sheet transport rollers, a sheet ejection roller for ejecting the sheet P outside the apparatus.

The image forming apparatus further includes a sheet transport unit for transporting the sheet P from the transfer position to a fixing position.

The above-described sheet transport units such as the finisher unit and the sheet feed unit are removable from the apparatus body, allowing easy detection and removal of a jammed sheet. When such a sheet transport unit is removed from the apparatus body, a rotary shaft of a sheet transport roller for transporting a sheet is disconnected from a drive shaft for transmitting a dive force to the sheet transport roller. When the sheet transport unit is pushed into the apparatus body, the rotary shaft of the sheet transport roller is connected to the drive shaft.

With this configuration, if the drive shaft is inclined with respect to the rotary shaft due to a variation in parts accuracy or assembly accuracy, the drive shaft might not be connected to the rotary shaft. Even if the drive shaft can be connected to the rotary shaft, an offset angle is formed between the rotary shaft and the drive shaft, resulting in uneven rotation of the sheet transport roller. The uneven rotation of the sheet transport roller causes fluctuation of the relative sheet transport speed of the sheet transport roller to the other units and therefore causes skew and warping, which may negatively affect the transfer performance and the fixing performance.

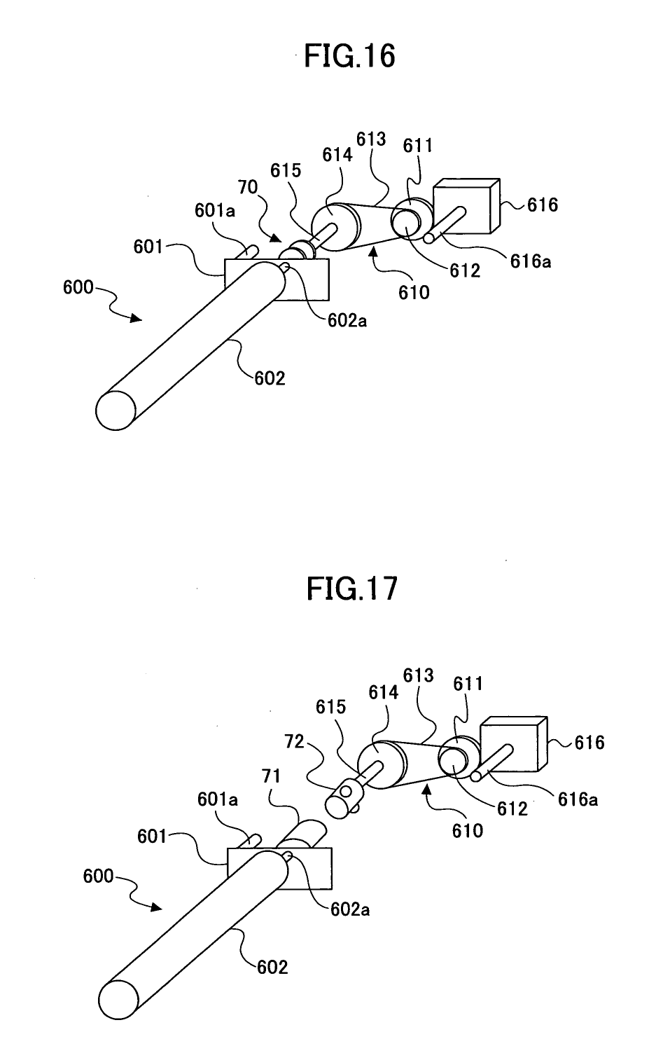

To obviate this problem, the above-described constant velocity joint may be used to connect the sheet transport unit, such as the finisher unit, the sheet feed unit, the reverse unit, and the ejection unit, to the drive shaft. With this connection, the sheet transport unit is positioned relative to the apparatus body in the radial direction, thereby enabling constant speed rotation of the sheet transport roller. A detailed description is given below with reference to FIGS. 16 and 17.

FIG. 16 is a schematic configuration diagram illustrating a sheet transport unit 600. FIG. 17 is a diagram illustrating how the sheet transport unit 600 is attached to the apparatus body.

The sheet transport unit 600 includes a sheet transport roller 602 and a driven transport roller (not shown) that presses against the sheet transport roller 602 to form a transport nip. The sheet transport roller 602 and the driven transport roller (not shown) are rotatably supported by a near side plate (not shown) and a far side plate 601 of a case of the sheet transport unit 600. A sheet transport unit sub reference pin 601a is provided on the far side plate 601.

In the apparatus body, a sheet transport motor 616 (a drive source) and a drive force transmission unit 610 are provided. The drive force transmission unit 610 includes an idler gear 611, a first pulley 612, a second pulley 614, a drive shaft 615, and a timing belt 613. A motor shaft 616a of the sheet transport motor 616 meshes with the idler gear 611. The first pulley 612 is coaxially attached to the idler gear 611. The second pulley 614 is fixed to the drive shaft 615. The timing belt 613 extends around the first pulley 612 and the second pulley 614.

A rotary shaft 602a (a driven shaft) of the sheet transport roller 602 extends through the far side plate 601 and is connected to the drive shaft 615 by a constant velocity joint 70.

Referring to FIG. 17, when attaching the sheet transport unit 600 to the apparatus body, the sheet transport unit sub reference pin 601a is inserted into a sub reference hole (not shown) formed in the apparatus body. When the sheet transport unit 600 is further inserted into the apparatus body, the sub reference pin 601a is guided by the sub reference hole (not shown), so that an inserting joint 72 attached to the drive shaft 615 is inserted into an annular space 71d of a receiving joint 71 attached to the rotary shat 602a. Thus the drive shaft 615 is connected to the rotary shaft 602a. In this way, the drive shaft 615 is connected to the rotary shaft 602a, so that the sheet transport unit 600 is positioned relative to and attached to the apparatus body.

Using the above-described constant velocity joint 70 for connection between the rotary shaft 602a of the sheet transport roller 602 of the sheet transport unit 600 and the drive shaft 615 enables connecting the drive shaft 615 to the rotary shaft 602a even if an offset angle is formed between the drive shaft 615 and the rotary shaft 602a. Furthermore, even if an offset angle is formed between the drive shaft 615 and the rotary shaft 602a, it is possible to transmit the rotation of the drive shaft 615 to the rotary shaft 602a at a constant speed, thereby enabling constant speed rotation of the sheet transport roller 602. Therefore, even with a variation in parts accuracy and assembly accuracy, it is possible to attach the sheet transport unit 600 to the apparatus body and to stably perform a sheet transport operation.

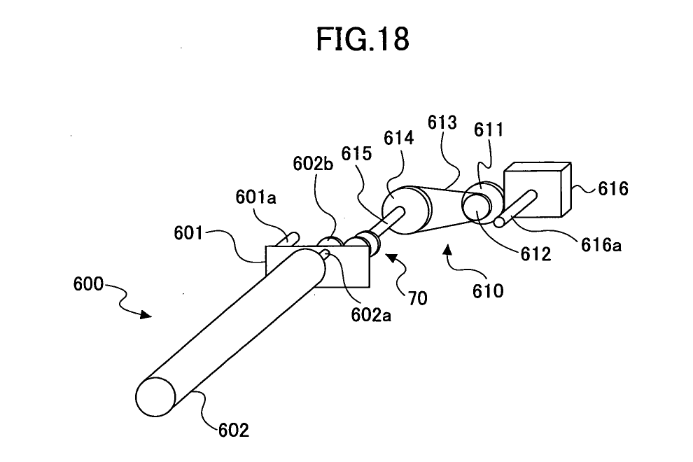

In the above description, the receiving joint 71 of the constant velocity joint 70 is attached to the rotary shaft 602a of the sheet transport roller 602. In an alternative embodiment shown in FIG. 18, a sheet transport roller gear 602b is attached to the rotary shaft 602a of the sheet transport roller 602. The sheet transport roller gear 602b meshes with a sheet transport driven gear (not shown) that is fixed to a driven shaft (not shown). The driven shaft (not shown) is rotatably attached to the far side plate 601. The receiving joint 71 is attached to the driven shaft (not shown). Thus, the drive shaft 615 is indirectly connected to the rotary shaft 602a of the sheet transport roller 602.

This invention is not limited to a tandem type intermediate transfer color image forming apparatus.

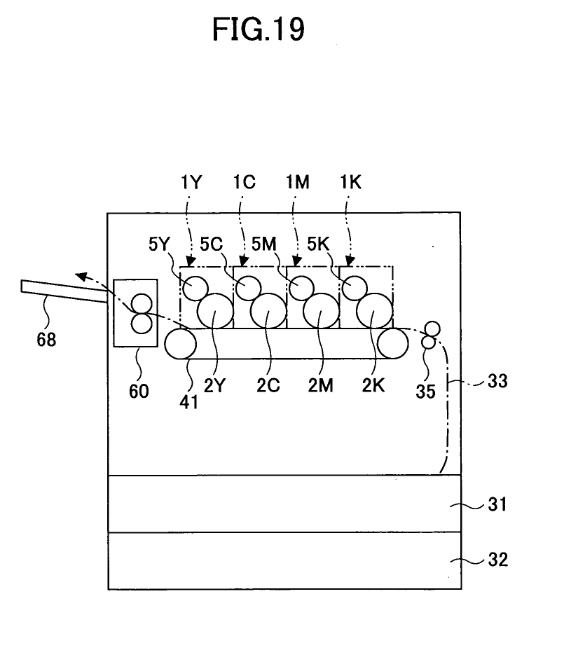

For example, the present invention is applicable to a tandem type direct transfer color image forming apparatus as shown in FIG. 19.

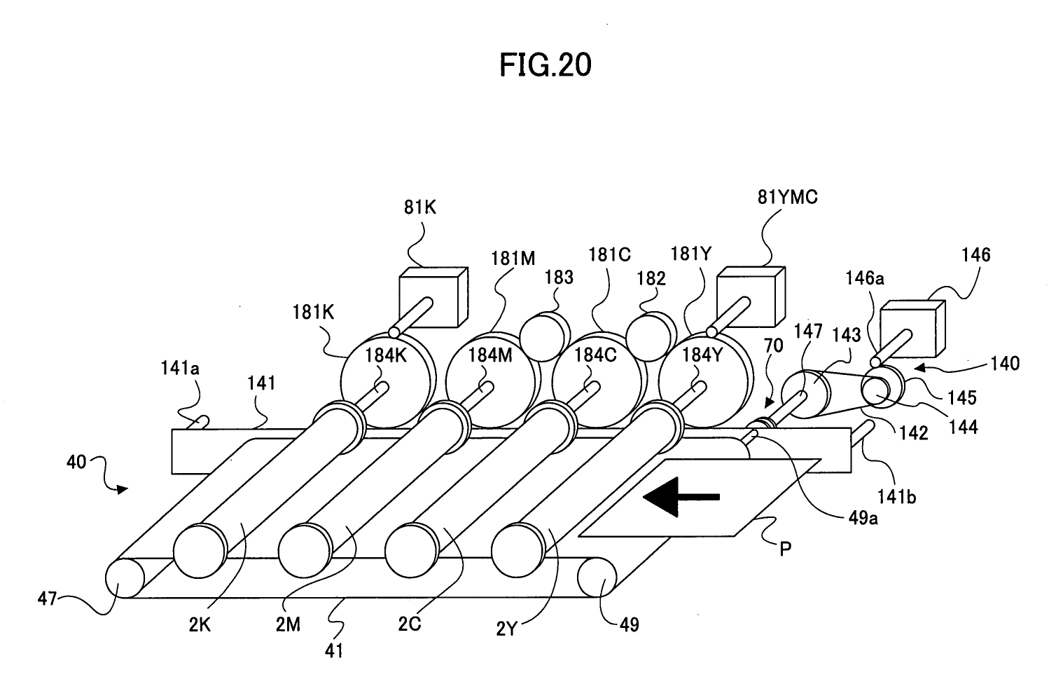

FIG. 20 shows an example in which a constant velocity joint 70 of an embodiment of the present invention is used to connect a rotary shaft 49a of a drive roller 49, which rotates a sheet transport belt (recording medium transport unit) 41 of a transfer unit 40 of the tandem type direct transfer color image forming apparatus, to a drive shaft 147.

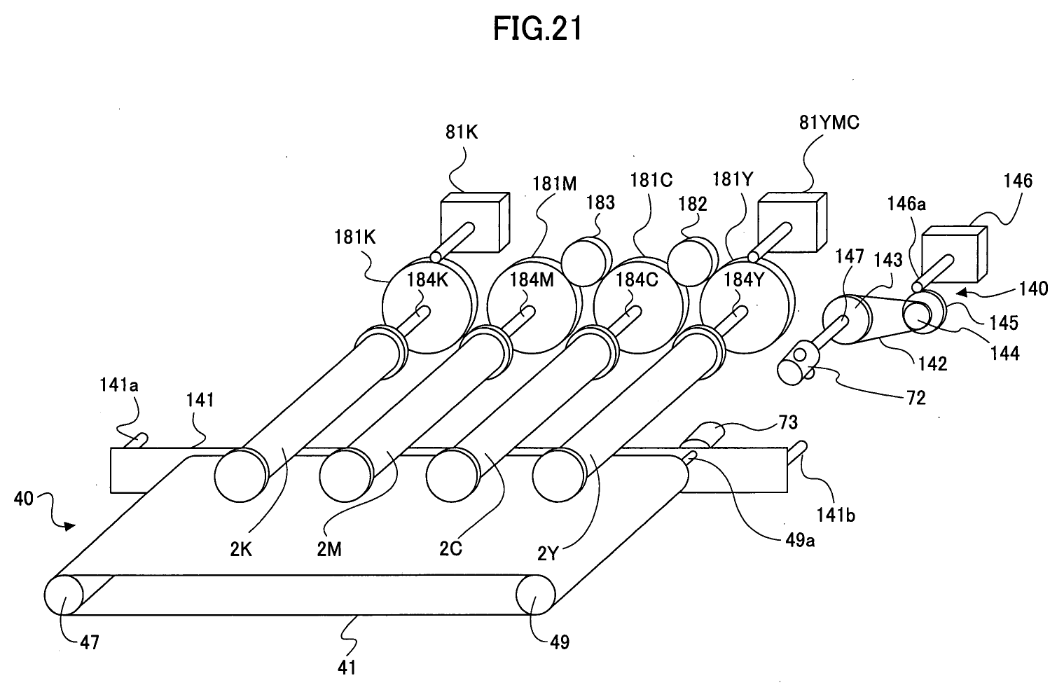

FIG. 21 is a diagram illustrating how the transfer unit 40 is attached to the tandem type direct transfer color image forming apparatus.

As shown in FIG. 20, the color image forming apparatus includes, in the apparatus body, a K photoreceptor motor 81K for rotating a K photoreceptor and a color photoreceptor motor 81YMC for rotating Y, M and C photoreceptors. A motor shaft of the K photoreceptor motor 81K meshes with a drum gear 181K.

A motor shaft of the color photoreceptor motor 81YMC meshes with a Y drum gear 181Y. A first idler gear 182 is disposed between and meshes with the Y drum gear 181Y and a C drum gear 181C. A second idler gear 183 is disposed between and meshes with the C drum gear 181C and an M drum gear 181M.

The drum gears 181Y, 181C, 181M, and 181K are fixed to drive shafts 184Y, 184C, 184M, and 184K, respectively. The drive shafts 184Y, 184C, 184M, and 184K are connected to rotary shafts of photoreceptors 2Y, 2C, 2M, and 2K, respectively, by constant velocity joints.

When the color photoreceptor motor 81YMC is driven, a drive force of the color photoreceptor motor 81YMC is transmitted to the Y drum gear 181Y via the motor shaft. The drive force transmitted to the Y drum gear 181Y is transmitted to the C drum gear 181C via the first idler gear 182. The drive force transmitted to the C drum gear 181C is transmitted to the M drum gear 181M via the second idler gear 183. Thus the Y, M, and C photoreceptors 2Y, 2M, and 2C are rotated by the color photoreceptor motor 81YMC.

Rotary shafts of the drive roller 49 and a driven roller 47, around which the intermediate transfer belt 41 extends, are rotatably supported by a near side plate (not shown) and a far side plate 141 of the case of the transfer unit 40. A transfer unit main reference pin 141b and a transfer unit sub reference pin 141a are provided on the far side plate 141 of the transfer unit 40.

In the apparatus body, an intermediate transfer motor 146 (a drive source) and a drive force transmission unit 140 are provided. The drive force transmission unit 140 includes an idler gear 145, a first pulley 144, a second pulley 143, a drive shaft 147, and a timing belt 142. A motor shaft 146a of the intermediate transfer motor 146 meshes with the idler gear 145. The first pulley 144 is coaxially attached to the idler gear 145. The second pulley 143 is fixed to the drive shaft 147. The timing belt 142 extends around the first pulley 144 and the second pulley 143.

The rotary shaft 49a (a driven shaft) of the drive roller 49 extends through the far side plate 141 and is connected to the drive shaft 147 by a constant velocity joint 70 of an embodiment of the present invention.

Referring to FIG. 21, when attaching the transfer unit 40 to the apparatus body, the transfer unit main reference pin 141b is inserted into a main reference hole (not shown) formed in the apparatus body, and the transfer unit sub reference pin 141a is inserted into a sub reference hole (not shown) formed in the apparatus body, so that the transfer unit 40 is positioned relative to the apparatus body. The transfer unit 40 that is positioned relative to the apparatus body is further inserted into the apparatus body, so that the rotary shaft 49a of the drive roller 49 is connected to the drive shaft 147 by the constant velocity joint 70. Thus the transfer unit 40 is attached to the apparatus body.

Using the above-described constant velocity joint 70 for the connection between the rotary shaft 49a of the drive roller 49 of the transfer unit 40 and the drive shaft 147 allows the rotation of the drive shaft 147 to be transmitted to the rotary shaft 49a at a constant speed even if an offset angle is formed between the drive shaft 147 and the rotary shaft 49a.

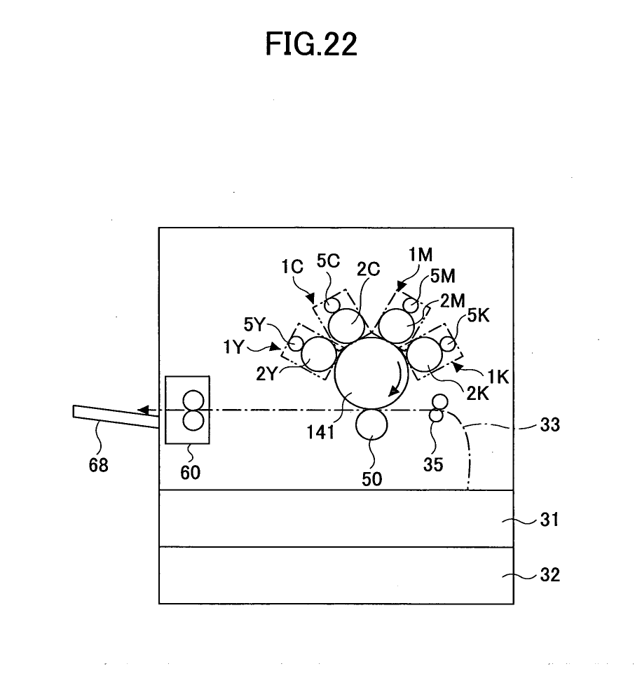

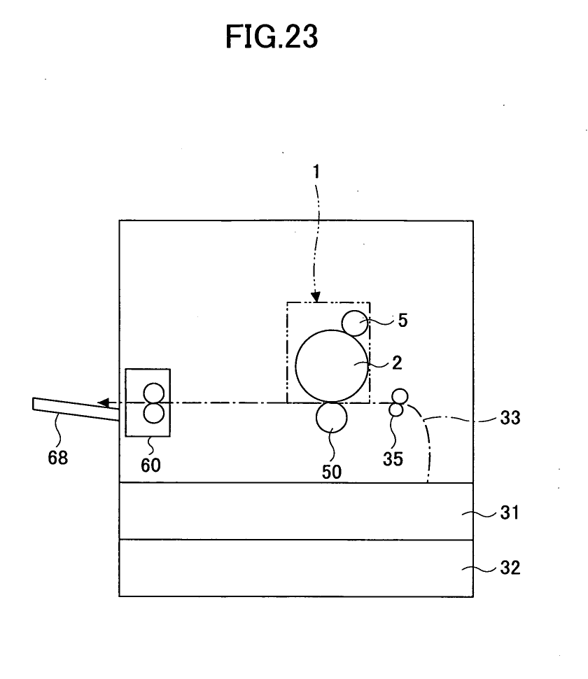

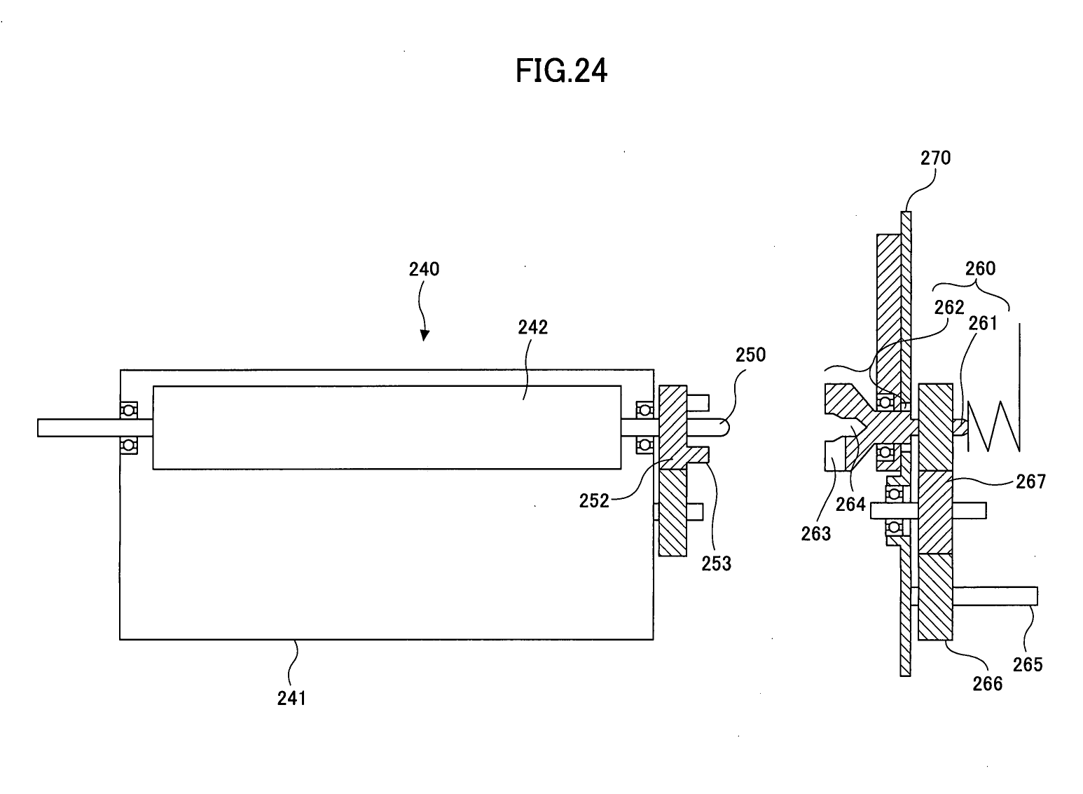

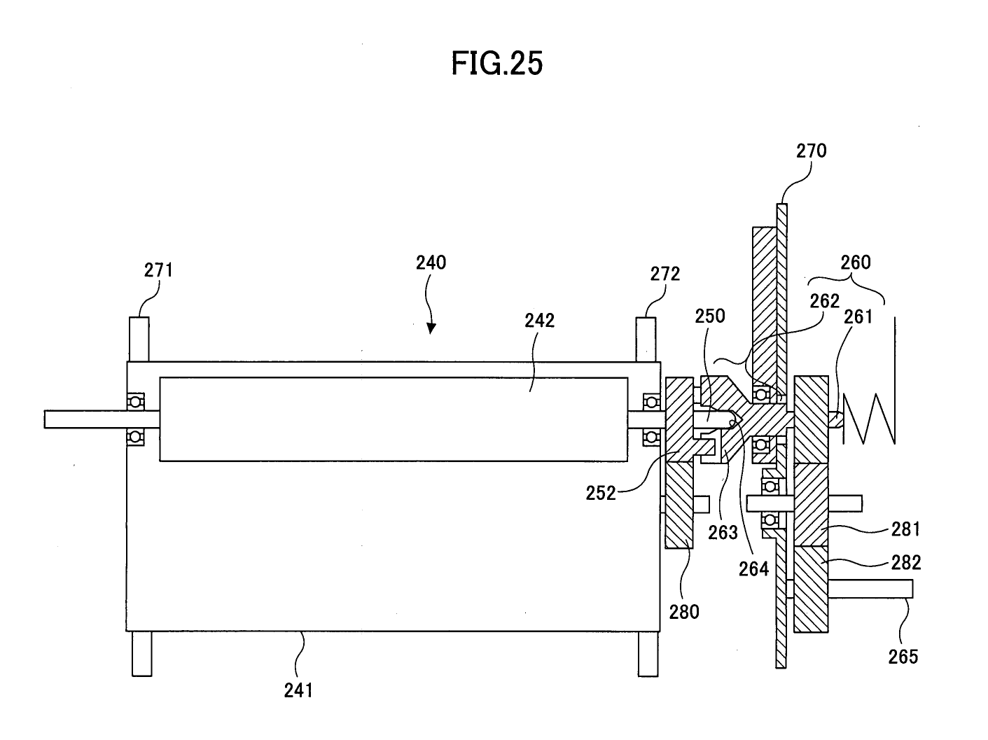

Referring to FIG. 22, the present invention is applicable to a color image forming apparatus using a drum type intermediate transfer body 141 in place of the intermediate transfer belt 41 of the tandem type intermediate transfer electrophotographic color image forming apparatus. The present invention is also applicable to a direct transfer monochrome image forming apparatus that includes a single developing unit 5 as described above and is configured to form an image on a photoreceptor 2 as an image carrier, transfers the image using a transfer roller 50, and records the image on a recording medium. In the case where the present invention is applied to a monochrome image forming apparatus, it is possible to rotate a developing roller at a constant speed, thereby preventing uneven density in a monochrome image.

In the above described embodiments and modified embodiments, a drive force transmission mechanism of the apparatus body for transmitting a drive force from a drive source to a drive shaft uses pulleys and a timing belt. However, the present invention is not limited to theses embodiments. For example, the present invention includes a system that transmits a drive force from a drive source using plural reduction gears and a system that directly transmits a drive force from a drive source without using a reduction mechanism. That is, the reduction mechanism of the apparatus body is not particularly limited and may be any type of reduction mechanism.

As described above, the image forming apparatus of the present embodiment uses the constant velocity joint 70 as a connection unit that connects the roller shaft 5k of the developing unit 5 as a driven shaft, which transmits a drive force to the developing roller 5g, to the drive shaft 91, which is rotated by a drive force from the drive motor 81 (a drive source) provided in the apparatus body. According to this configuration, even if an offset angle θ is formed between the drive shaft 91 and the roller shaft 5k, because the balls 73 slide in the axial direction in the annular space 71d between the inner grooves 71f and the outer grooves 71e of the receiving joint 71, it is possible to rotate the roller shaft 5k at a constant speed. It is therefore possible to rotate the developing roller 5g at a constant speed and prevent image defects such as uneven print density without improving the attachment accuracy and parts accuracy for preventing formation of the offset angle θ. Accordingly, it is possible to prevent image defects such as uneven print density while reducing the production cost and the parts cost. Furthermore, because the constant velocity joint 70 is attached to the roller shaft 5k of the developing roller 5g that has the highest torque among plural rotating bodies of the developing unit 5, it is possible to prevent large torque being applied to a drive force transmission mechanism of the developing unit 5, thereby extending the service life of the drive force transmission mechanism of the developing unit 5.

According to the present embodiment, the receiving joint 71 and the inserting joint 72 are formed of resin that provides sliding properties. Accordingly, it is possible to smoothly slide the balls 73 along the track grooves of the receiving joint 71 without applying lubricant such as grease to the annular space 71d. Therefore, it is possible to reduce the operating noise compared to a receiving joint 71 and an inserting joint 72 formed of a metal material.

Similarly, in the case the balls 73 are formed of resin that provides sliding properties, it is possible to smoothly slide the balls 73 along the track grooves of the receiving joint 71 without applying lubricant such as grease to the annular space 71d. It should be apparent that all of the balls 73, the receiving joint 71, and the inserting joint 72 may be formed of resin that provides sliding properties.

Furthermore, because the resin that provides sliding properties is an injection-moldable material, the balls, the receiving joint 71, and the inserting joint 72 can easily be formed by injection molding.

The receiving joint 71 having a shorter service life than that of the inserting joint 72 is attached to the driven shaft. According to this configuration, removing the removable unit from the apparatus body allows replacement of the receiving joint 71. Therefore, compared to the case where the inserting joint 72 is attached to the driven shaft, maintenance can be performed more easily.

The diameter of each through hole 72b as a ball holding hole of the inserting joint 72 is greater than the diameter of the ball 73, and the retaining projections 72d and 72e prevent the ball 73 from coming out of the outer through hole 72b. This configuration allows radial movement of the ball 73 within the through hole 72b. Therefore, during insertion of the ball holding portion 72a of the inserting joint 72 into the receiving joint 71, when the ball 73 hits the outer circular portion 71b of the receiving joint 71, the ball 73 moves toward the central axis. As a result, the length of the ball 73 projecting out of the ball holding portion 72a is reduced, thereby allowing smooth insertion of the ball holding portion 72a of the inserting joint 72 into the annular space 71d of the receiving joint 73. Thus, the developing unit 5 can more easily be attached to the image forming apparatus body.

The distance D from the outer groove 71e to the inner groove 71f is made greater than a diameter B of the ball 73 to establish tolerance, and therefore gaps are formed between the ball 73 and the outer groove 71e and between the ball 73 and the inner groove 71f, respectively. This prevents the ball 73 from being press fitted between the outer groove 71e and the inner groove 71f, thereby preventing an increase in the sliding resistance of the ball 73 to the outer groove 71e and the inner groove 71f. Therefore it is possible to prevent wear of the outer groove 71e and the inner groove 71f and a creep phenomenon and to extend the service life of the receiving joint 71. Furthermore, because the ball 73 smoothly slides between the outer groove 71e and the inner groove 71f, it is possible to rotate the developing roller 5g at a constant speed.

A guide pin 121 as a guide member for guiding attachment of the developing unit 5 to the apparatus body is provided in the apparatus body, while the guide hole 18 as a guided portion to be guided by the guide pin 121 is formed in the developing unit 5. According to this configuration, the developing unit 5 is guided to a position where the receiving joint engages the inserting joint 72, and therefore the inserting joint 72 can easily be inserted into the receiving joint 71. Thus the removable unit can more easily be attached to the image forming apparatus body.

The electromagnetic clutch 93 is provided in the transmission mechanism unit 90 that transmits a drive force of the drive motor (a drive source) to the drive shaft. When inserting the inserting joint 72 into the receiving joint 71, the electromagnetic clutch 93 disconnects the drive motor from the drive shaft. According to this configuration, during insertion of the inserting joint 72 into the receiving joint 71, the drive shaft can be rotated without receiving the torque of the drive motor. That is, during insertion of the inserting joint 72 into the receiving joint 71, the drive shaft rotates easily. Therefore, if the phase of the balls 73 is not matched to the phase of the track grooves, the inserting joint 72 is easily rotated, so that the phase of the balls 73 is matched to the phase of the track grooves. Thus, the balls 73 can be guided to the track grooves while reducing the insertion resistance of the developing unit 5.

A transmission mechanism is provided that transmits a drive force from the roller shaft as a driven shaft to the transport screw. A clutch is provided in the transmission mechanism. When inserting the inserting joint 72 into the receiving joint 71, the clutch disconnects the roller shaft from the transmission mechanism. According to this configuration, during insertion of the inserting joint 72 into the receiving joint 71, the roller shaft can be rotated without receiving the inertial force of the transport screw as a rotating body. Therefore, if the phase of the balls 73 is not matched to the phase of the track grooves, the receiving joint 71 is easily rotated, so that the phase of the balls 73 is matched to the phase of the track grooves. Thus, the balls 73 can be guided to the track grooves while reducing the insertion resistance of the developing unit 5.

The present application is based on Japanese Priority Application No. 2007-205799 filed on Aug. 7, 2007, No. 2007-282738 filed on Oct. 31, 2007, and No. 2008-100724 filed on Apr. 8, 2008, with the Japanese Patent Office, the entire contents of which are hereby incorporated herein by reference.

What is claimed is:

1. An image forming apparatus, comprising: a unit that includes a rotating body and is detachable from an apparatus body; and a connection unit configured to connect a driven shaft provided in the unit to a drive shaft provided in the apparatus body, the driven shaft being configured to transmit a drive force to the rotating body, the drive shaft being configured to be rotated by a drive force of a drive source; wherein the unit is positioned relative to the apparatus body by connecting the drive shaft and the driven shaft with the connection unit,
wherein the rotating body includes at least one of a developing roller, a drive roller of an intermediate transfer belt, a drive roller of a sheet transport belt, a roller configured to transport a sheet, and a secondary transfer roller; and
wherein the connection unit is a constant velocity joint that includes a receiving joint attached to one of the driven shaft and the drive shaft, the receiving joint including an annular space having one open end and plural track grooves axially extending in an outer wall and an inner wall of the annular space and being equally spaced from each other in a circumferential direction; and an inserting joint attached to the other one of the driven shaft and the drive shaft and configured to be partly inserted into the annular space of the receiving joint, the inserting joint holding plural balls that slide along the corresponding track grooves of the receiving joint, the constant velocity joint being configured to connect the driven shaft and the drive shaft by engaging the balls held by the inserting joint into the corresponding track grooves.

2. The image forming apparatus as claimed in claim 1, wherein the receiving joint and the inserting joint are formed of a resin that provides sliding properties.

3. The image forming apparatus as claimed in claim 1, wherein the balls are formed of a resin that provides sliding properties.

4. The image forming apparatus as claimed in claim 2, wherein the resin that provides sliding properties is an injection-moldable synthetic resin.

5. The image forming apparatus as claimed in claim 1, wherein the receiving joint is attached to the driven shaft.

6. The image forming apparatus as claimed in claim 1, wherein the inserting joint includes ball holding holes having a diameter greater than a diameter of the balls and retaining projections each projecting from an inner surface at an outer peripheral end of the corresponding ball holding hole to prevent the ball from coming out of the ball holding hole.

7. The image forming apparatus as claimed in claim 1, wherein a distance between the track grooves and surfaces opposing the track grooves is greater than a diameter of the balls.

8. The image forming apparatus as claimed in claim 1,
wherein the apparatus body includes a guide member that guides attachment of the unit; and
the unit includes a guided member to be guided by the guide member.

9. The image forming apparatus as claimed in claim 1, wherein a clutch is provided in a drive force transmission mechanism that transmits the drive force of the drive source to the drive shaft, the clutch being configured to disconnect the drive source from the drive shaft when the balls held by the inserting joint are caused to engage the track grooves of the receiving joint.

10. The image forming apparatus as claimed in claim 1,
wherein the unit includes another rotating body; and
wherein a clutch is provided in a unit transmission mechanism that transmits the drive force from the driven shaft to the rotating bodies and the other rotating body, the clutch being configured to disconnect the driven shaft from the unit transmission mechanism when the balls held by the inserting joint are caused to engage the track grooves of the receiving joint.
